(19) United States
(12) Patent Application Publication
(10) Pub. No.: US 2024/0133778 A1
(43) Pub. Date: Apr. 25, 2024

(54) VOLATILE ACETATES AND FORMATES

(71) Applicant: George Mason Research Foundation, Inc., Fairfax, VA (US)

(72) Inventors: Lance Liotta, Bethesda, MD (US); Marissa Ashton Howard, Richmond, VA (US); Amanda Nicole Haymond Still, Manassas, VA (US); Thomas Raymond Philipson, Fairfax, VA (US); Philip Andrew Pappalardo, Barryville, NY (US)

(73) Assignee: George Mason Research Foundation, Inc., Fairfax, VA (US)

(21) Appl. No.: 18/375,224

(22) Filed: Sep. 29, 2023

Related U.S. Application Data
(60) Provisional application No. 63/377,887, filed on Sep. 30, 2022.

(51) Int. Cl. G01N 1/30; G01N 21/64

(52) U.S. Cl. CPC G01N 1/30; G01N 21/6428; G01N 21/6458; G01N 2001/2886; G01N 2001/302

(57) ABSTRACT

A visualization fluid composition is provided to enhance visualization and analysis of samples. The visualization fluid composition includes a low molecular weight ester, ether, or formate moiety, a volatile organic liquid chemical component, stabilization components, preservation components; and an image color adjusting moiety.

### CROSS-REFERENCE TO RELATED APPLICATION

The present application claims the benefit of priority to U.S. Provisional Application No. 63/377,887 filed Sep. 30, 2022, the entire contents of which are hereby incorporated by reference.

### FIELD

The present technology relates to tissue visualization and digital pathology. More specifically, the present technology relates to the use of volatile acetates and formates in tissue visualization and digital pathology.

### BACKGROUND

The following description of the background of the present technology is provided simply as an aid to understanding the present technology and is not admitted to describe or constitute prior art to the present technology.

High fidelity high resolution full color microscopic visualization of samples for tissue molecular analysis, including Laser Capture Microdissection (LCM) or scanning matrix-assisted laser desorption ionization (MALDI), or probe/tool capture, of labeled cells, has long been challenging to achieve. The interface between the slide and microdissection or cellular analysis tool, such as the LCM cap, or the probes or capture methods used in molecular analysis (NanoString, Scanning MALDI) has to be done with full access to the tissue surface. For instance, LCM is a technique used to obtain a small subpopulation of cells from a tissue sample through the excitation of an ethylene-vinyl acetate (EVA) polymer film on the surface of a capture cap. The melted EVA polymer then impregnates the sample with the assistance of gravity. When the cap is removed, the impregnated sample is still attached to the surface of the cap, so it is effectively obtained. The captured sample can then be used for downstream analyses like reverse-phase protein array (RPPA).

As recognized by the inventors of the present disclosure, there is a need for a visualization chemistry that is applied on the open face tissue section to permit full color high fidelity histologic and cytologic digital imaging, at low and very high magnification to permit full diagnostic-quality histomorphology, for any tissue that is unstained, chemically stained, immunostained with a fluorescent or colorimetric probe, permitting direct high resolution tissue sampling. In addition, there is a need for light absorbing compounds that are tunable for laser capture microdissection for infrared and near-ultraviolet (UV) microdissections. The present disclosure addresses these needs.

### SUMMARY

The present disclosure provides a class of volatile organic compounds that provide outstanding visualization of an unstained tissue equivalent or superior to a cover-slipped tissue section and are useful for fluorescent, immunohistochemical, or non-stained tissue for diagnostic interpretation and tissue capture of samples. In this manner, superior imaging of samples can be realized.

In more detail, the present disclosure avoids defects associated with allowing full access of a tissue surface, which creates an air refractive index mismatch that distorts the image, causing a darkening and loss of resolution and color, with a very poor-quality image, preventing the technician or pathologist from fully visualizing the tissue section (FIG. 1A). As an alternative, a coverslip can be placed on the sample, but doing so compromises the sample and leads to an adjacent section to be used (FIG. 1A). Although an adjacent section may be used, using one section instead of two effectively doubles the experiments possible with each section of tissue. Attempts have been made to use common pathological fluids like oil immersion, xylene, or mounting media to visualize the slide; however, these fluids damage or adhere to the tissue, preventing downstream molecular analyses.

In addition, LCM tissue capture relies on a thermoplastic polymer, typically an EVA polymer, which contains a compound which absorbs and transfers the laser energy as heat to melt the EVA polymer to allow for tissue capture without damaging the tissue. These compounds incorporated onto the tissue capture interface are tuned for earlier-generation laser microdissection systems which utilize infrared lasers (beam wavelengths from roughly 750 nm to 1 mm). This infrared wavelength range is larger than a single mammalian cell, and the laser spot size expands as it passes through the tissue capture interface, making current system configurations a barrier to microdissection of smaller tissue regions and single cells (FIG. 4). New laser capture microdissection system configurations utilizing 405 nm near-UV lasers are capable of capturing regions of 10 microns (single cell) (FIG. 4). However, the laser capture microdissection thermo-polymer interface is not compatible for this type of laser microdissection.

As noted, the present disclosure provides a class of volatile organic compounds that provide outstanding visualization of an unstained tissue equivalent or superior to a cover-slipped tissue section and useful for fluorescent, immunohistochemical, or non-stained tissue for diagnostic interpretation and tissue capture of sample procedures (FIGS. 1B-1C). The present disclosure also provides various methods to visualize the samples with integrated automated steps. The present disclosure also provides for novel mixtures of electromagnetic exothermic light-absorbing compounds that are tunable for laser capture microdissection for infrared and near-UV microdissections. It is to be understood that the disclosed embodiments are merely exemplary, and accordingly, the aspects of the present disclosure set forth herein may be embodied in various and alternative forms. The specific structural and functional details disclosed herein are not to be interpreted as limiting but merely as a basis for the claims and as a representative basis for teaching one skilled in the art to employ the techniques of the present disclosure.

In a first aspect, the present disclosure provides a visualization fluid composition of matter for tissue visualization including one or more of the following elements: a) a low molecular weight ester or ether moiety, b) a volatile organic liquid chemical component, stabilization components, c) preservation components, and d) an image color adjusting moiety. In some embodiments of this first aspect, the visualization fluid composition is housed in a sealed container that is impermeable to water vapor for direct application of the solution to a slide. In some embodiments of this first aspect, the container is made of a material that is inert to degradation by the composition or components thereof. In some further embodiments of this first aspect, the container housing the visualization fluid composition is integrated into a dispensing method such as a tear-top squeeze applicator for single use application into a tissue slide. In some other embodiments, the visualization fluid composition may be applied by robotic mechanisms to allow for high throughput scanning and visualization of multiple slides at one time.

In some embodiments according to this first aspect, the low molecular weight ester, ether, or formate moiety may include one or more of the following properties: a) a refractive index between 1.3-1.5, b) optical clarity defined as greater than approximately 90% transmittance of incident light of the range of approximately 400 nm to approximately 800 nm, c) a vapor pressure between approximately 5 to approximately 25 kPa at room temperature (approximately 22° C.), and d) less than approximately 1% water content (anhydrous). In some further embodiments according to this first aspect, the low molecular weight ester, ether, or formate moiety does not interfere with molecular analytes within the sample tissue. In some further embodiments of this first aspect, the low molecular weight ester, ether, or formate moiety does not interfere with the microdissection process. In some embodiments of this first aspect, the low molecular weight ester, ether, or formate moiety includes a short-chain organic acetate compound. In some further embodiments of this first aspect, the short-chain organic acetate compound can be ethyl acetate, methyl acetate, propyl acetate, butyl acetate, or any isomer or combination of isomers thereof. In some embodiments of this first aspect, the low molecular weight ester, ether, or formate moiety includes a short-chain organic formate compound. In some further embodiments of this first aspect, the short-chain organic formate compound includes methyl formate, ethyl formate, propyl formate, butyl formate, or any isomer or combination of isomers thereof. In some embodiments of this first embodiment, the low molecular weight ester, ether, or formate moiety includes a mixture of a short-chain acetate compound and a short-chain formate compound.

In some embodiments of this first aspect, the volatile organic liquid chemical component may include one or more of the following properties: a) a refractive index between 1.3-1.5, b) optical clarity defined as greater than 90% transmittance of incident light of the range of approximately 400 nm—approximately 800 nm, c) a vapor pressure between approximately 5—approximately 25 kPa at room temperature (approximately 22° C.), and d) less than 1% water content (anhydrous). In some further embodiments of this first aspect, the volatile organic liquid chemical component does not interfere with molecular analytes within the sample tissue. In some further embodiments according to this first aspect, the volatile organic liquid chemical component does not interfere with the microdissection process. In some embodiments according to this first aspect, the volatile organic liquid chemical component includes a short-chain alcohol solvent. In some further embodiments according to this first aspect, the short-chain alcohol solvent includes methanol, ethanol, propanol, or any isomer or combination of isomers thereof. In some other embodiments according to this first aspect, the volatile organic liquid chemical component includes a mixture of short-chain alcohol solvents, including methanol, ethanol, propanol, or any isomer or combination of isomers thereof. In some other embodiments according to this first aspect, the volatile organic liquid chemical component includes acetonitrile. In some other embodiments according to this first aspect, the volatile organic liquid chemical components include a mixture of a) short-chain alcohol solvents, including methanol, ethanol, propanol, and any isomer or combination of isomers thereof, and b) acetonitrile. In some other embodiments according to this first embodiment, the volatile organic liquid chemical component includes of a mixture of a) short-chain acetate compounds, including ethyl acetate, methyl acetate, propyl acetate, butyl acetate, and any isomer or combination of isomers thereof, and b) short-chain formate compounds, including ethyl formate, methyl formate, propyl formate, butyl formate, and any isomer or combination of isomers thereof.

In some embodiments according to this first aspect, the stabilization components may allow for absorption of water, such that the volatile organic liquid chemical component is included of less than 1% water. In some embodiments according to this first aspect, the stabilization components may include hygroscopic salts. In some further embodiments according to this first aspect, the hygroscopic salts include calcium chloride, calcium sulfate, magnesium sulfate, potassium sulfate, or sodium sulfate or a combination thereof. In some embodiments according to this first aspect, the stabilization components are added to the volatile organic liquid chemical component.

In some embodiments according to this first aspect, the preservation component may include a denaturant chemical component that prevents degradation of analytes, such as DNA or RNA, within the tissue sample. In some further embodiments according to this first aspect, the preservation components include a chaotropic agent. In some other further embodiments according to this first aspect, the preservation components include an RNase inhibitor. In some further embodiments according to this first aspect, the RNase inhibitor is Ribonucleoside Vanadyl Complex.

In some embodiments according to this first aspect, the image color adjusting moiety includes a chemical dye. In some embodiments according to this first aspect, the image color adjusting moiety includes chemical dyes, such as the class of Fast Dyes. In some embodiments according to this first aspect, the image color adjusting moiety includes a chemical dye within the 600-650 nm wavelength.

In some embodiments according to this first aspect, the visualization fluid composition is applied to the tissue by a tear-top squeeze applicator. In some further embodiments according to this first aspect, the tear-top squeeze applicator may include one or more of the following properties or components: (i) a material that is inert to degradation via the volatile organic liquid chemical component, (ii) a bulb or dropper region in which the volatile organic liquid chemical component and stabilization components are sealed, is able to be opened without special tools, and (iii) a sufficient volatile organic liquid chemical component to wet at least one histological tissue section. In some further embodiments of the first aspect, the tear-top squeeze applicator includes a plastic pouch with a tear-off or twist-off seal. In some other further embodiments of the first aspect, the tear-top squeeze applicator includes a dropper that is used to directly apply the volatile organic liquid chemical component to a tissue surface after a seal is removed. In some other further embodiments of the first aspect, the tear-top squeeze applicator includes a filter paper or filter between a bulb containing the liquid and a dispensing spout to avoid dispensing any stabilization components, if insoluble in the volatile organic liquid chemical component, onto the tissue surface.

In some embodiments according to this first aspect, the visualization fluid composition is applied to the tissue by automated robotic mechanisms. In some embodiments according to this first aspect, the visualization fluid composition is applied to the tissue by a user.

In a second aspect, the present disclosure provides a method of visualizing tissue using the visualization fluid composition. In some embodiments of this second aspect, the method includes: a) application of the visualization fluid composition onto a sample mounted onto a slide by an operator, b) scanning and imaging the slide digitally, optically, and/or microscopically, c) analyzing the images of the slides to identify a region of interest, and d) molecular analysis of the regions of interest.

In some embodiments of this second aspect, the low molecular weight ester, ether, or formate moiety may include one or more of the following properties: a) a refractive index between 1.3-1.5, b) optical clarity defined as greater than 90% transmittance of incident light of the range of 400-800 nm, c) a vapor pressure between 5-25 kPa at room temperature (about 22° C.), and d) less than 1% water content (anhydrous). In some embodiments of this second aspect, the low molecular weight ester, ether, or formate moiety does not interfere with molecular analytes within the sample tissue. In some embodiments of this second aspect, the low molecular weight ester, ether, or formate moiety does not interfere with the microdissection process. In some embodiments of this second aspect, the low molecular weight ester, ether, or formate moiety includes a short-chain organic acetate compound. In some embodiments of this second aspect, the short-chain organic acetate compound includes ethyl acetate, methyl acetate, propyl acetate, butyl acetate, or any isomer or combination of isomers thereof. In some embodiments of this second aspect, the low molecular weight ester, ether, or formate moiety includes a short-chain organic formate compound. In some embodiments of this second aspect, the short-chain organic formate compound includes methyl formate, ethyl formate, propyl formate, butyl formate, or any isomer or combination of isomers thereof. In some embodiments of this second embodiment, the low molecular weight ester, ether or formate moiety includes a mixture of a short-chain acetate compound and a short-chain formate compound.

In some embodiments of this second aspect, the volatile organic liquid chemical component may include one or more of the following properties: a) a refractive index between 1.3-1.5, b) optical clarity defined as greater than 90% transmittance of incident light of the range of 400-800 nm, c) a vapor pressure between 5-25 kPa at room temperature (about 22° C.), and d) less than 1% water content (anhydrous). In some embodiments of this second aspect, the volatile organic liquid chemical component does not interfere with molecular analytes within the sample tissue. In some embodiments of this second aspect, the volatile organic liquid chemical component does not interfere with the microdissection process. In some embodiments of this second aspect, the volatile organic liquid chemical component includes a short-chain alcohol solvent. In some further embodiments of this second aspect, the short-chain alcohol solvent includes methanol, ethanol, propanol, or any isomer or combination of isomers thereof. In some other embodiments of this second aspect, the volatile organic liquid chemical component includes a mixture of short-chain alcohol solvents, including methanol, ethanol, propanol, or any isomer or combination of isomers thereof. In some other embodiments of this second aspect, the volatile organic liquid chemical component includes acetonitrile. In some other embodiments of this second aspect, the volatile organic liquid chemical components include a mixture of a) short-chain alcohol solvents, including methanol, ethanol, propanol, and any isomer or combination of isomers thereof, and b) acetonitrile. In some other embodiments of this second embodiment, the volatile organic liquid chemical component includes of a mixture of a) short-chain acetate compounds, including ethyl acetate, methyl acetate, propyl acetate, butyl acetate, and any isomer or combination of isomers thereof, and b) short-chain formate compounds, including ethyl formate, methyl formate, propyl formate, butyl formate, and any isomer or combination of isomers thereof.

In some embodiments of this second aspect, the stabilization components may exhibit the following property: absorption of water, such that the volatile organic liquid chemical component is included of less than 1% water. In some embodiments of this second aspect, the stabilization components may include hygroscopic salts. In some embodiments of this second aspect, the hygroscopic salts include calcium chloride, calcium sulfate, magnesium sulfate, potassium sulfate, or sodium sulfate. In some embodiments of this second aspect, the stabilization components are added to the volatile organic liquid chemical component.

In some embodiments of this second aspect, the preservation component may include a denaturant chemical component that prevents degradation of analytes, such as DNA or RNA, within the tissue sample. In some further embodiments of this second aspect, the preservation components include a chaotropic agent. In some other embodiments of this second aspect, the preservation components include an RNase inhibitor. In some embodiments of this second aspect, the RNase inhibitor is Ribonucleoside Vanadyl Complex.

In some embodiments of this second aspect, the image color adjusting moiety includes a chemical dye. In some embodiments of this second aspect, the image color adjusting moiety includes chemical dyes, such as the class of Fast Dyes. In some embodiments of this second aspect, the image color adjusting moiety includes a chemical dye within the 600-650 nm wavelength.

In some embodiments of this second aspect, the visualization fluid composition is applied to the tissue by a tear-top squeeze applicator. In some further embodiments of this second aspect, the tear-top squeeze applicator may include one or more of the following properties: (i) a material that is inert to degradation via the volatile organic liquid chemical component, (ii) a bulb or dropper region in which the volatile organic liquid chemical component and stabilization components are sealed, is able to be opened without special tools, and (iii) a sufficient volatile organic liquid chemical component to wet at least one histological tissue section. In some further embodiments of the second aspect, the tear-top squeeze applicator includes a plastic pouch with a tear-off or twist-off seal. In some other further embodiments of the second aspect, the tear-top squeeze applicator includes a dropper that is used to directly apply the volatile organic liquid chemical component to a tissue surface after a seal is removed. In some other further embodiments of the second aspect, the tear-top squeeze applicator includes a filter paper or filter between a bulb containing the liquid and a dispensing spout to avoid dispensing any stabilization components, if insoluble in the volatile organic liquid chemical component, onto the tissue surface. In some embodiments of this second aspect, the applicator is made of a material that is inert to degradation by the composition or components thereof.

In some embodiments of this second aspect, the visualization fluid composition is applied to the tissue by automated robotic mechanisms. In some embodiments of this second aspect, the visualization fluid composition is applied to the tissue by a user.

In some embodiments of this second aspect, the operator is a human user or a robot. In some embodiments of this second aspect, step (c) of the method is conducted without further direct visual inspection of the sample. In some further embodiments of this second aspect, step (c) of the method includes combining the images from step (b) with normalization techniques to modify the image. In some further embodiments of this second aspect, the normalization technique includes histogram stretching. In some further embodiments of this second aspect, the normalization technique includes white balancing.

In some other further embodiments of this second aspect, step (c) of the method includes subjecting the images from step (b) to machine-learning software to identify the regions of interest. In some further embodiments of this second aspect, the resulting marked-up image is sent electronically to a receiver. In some further embodiments of this second aspect, the receiver is a user. In some other further embodiments of this second aspect, the receiver is a machine, such as an automated or manually operable device. In some embodiments, the machine is a microsampling instrument or laser capture instrument. In some embodiments of this second aspect, the method includes e) microdissection or microsampling of the regions of interest based on the result of the molecular analysis, wherein there is no further requirement for optical or microscopic visualization of the sample.

In a third aspect, the present disclosure provides a method of visualizing tissue using the visualization fluid composition. In some embodiments of this second aspect, the method includes: a) application of the visualization fluid composition onto a sample mounted onto a slide by an operator, b) scanning and imaging the slide digitally, optically, and/or microscopically, c) analyzing the images of the slides to identify a region of interest, d) molecular analysis of the regions of interest, and e) microdissection of the sample using a near-UV laser flash system.

In some embodiments of this third aspect, the low molecular weight ester, ether, or formate moiety may include one or more of the following properties: a) a refractive index between 1.3-1.5, b) optical clarity defined as greater than 90% transmittance of incident light of the range of 400-800 nm, c) a vapor pressure between 5-25 kPa at room temperature (about 22° C.), and d) less than 1% water content (anhydrous). In some further embodiments of this third aspect, the low molecular weight ester, ether, or formate moiety does not interfere with molecular analytes within the sample tissue. In some further embodiments of this third aspect, the low molecular weight ester, ether, or formate moiety does not interfere with the microdissection process. In some embodiments of this third aspect, the low molecular weight ester, ether, or formate moiety includes a short-chain organic acetate compound. In some embodiments of this third aspect, the short-chain organic acetate compound includes ethyl acetate, methyl acetate, propyl acetate, butyl acetate, or any isomer or combination of isomers thereof. In some embodiments of this third aspect, the low molecular weight ester, ether, or formate moiety includes a short-chain organic formate compound. In some further embodiments of this third aspect, the short-chain organic formate compound includes methyl formate, ethyl formate, propyl formate, butyl formate, or any isomer or combination of isomers thereof. In some embodiments of this third embodiment, the low molecular weight ester, ether, or formate moiety includes a mixture of a short-chain acetate compound and a short-chain formate compound.

In some embodiments of this third aspect, the volatile organic liquid chemical component may include one or more of the following properties: a) a refractive index between 1.3-1.5, b) optical clarity defined as greater than 90% transmittance of incident light of the range of 400-800 nm, c) a vapor pressure between 5-25 kPa at room temperature (about 22° C.), and d) less than 1% water content (anhydrous). In some further embodiments of this third aspect, the volatile organic liquid chemical component does not interfere with molecular analytes within the sample tissue. In some further embodiments of this third aspect, the volatile organic liquid chemical component does not interfere with the microdissection process. In some embodiments of this third aspect, the volatile organic liquid chemical component includes a short-chain alcohol solvent. In some further embodiments of this third aspect, the short-chain alcohol solvent includes methanol, ethanol, propanol, or any isomer or combination of isomers thereof. In some other embodiments of this third aspect, the volatile organic liquid chemical component includes a mixture of short-chain alcohol solvents, including methanol, ethanol, propanol, or any isomer or combination of isomers thereof. In some other embodiments of this third aspect, the volatile organic liquid chemical component includes acetonitrile. In some other embodiments of this third aspect, the volatile organic liquid chemical components include a mixture of a) short-chain alcohol solvents, including methanol, ethanol, propanol, and any isomer or combination of isomers thereof, and b) acetonitrile. In some other embodiments of this third embodiment, the volatile organic liquid chemical component includes of a mixture of a) short-chain acetate compounds, including ethyl acetate, methyl acetate, propyl acetate, butyl acetate, and any isomer or combination of isomers thereof, and b) short-chain formate compounds, including ethyl formate, methyl formate, propyl formate, butyl formate, and any isomer or combination of isomers thereof

In some embodiments of this third aspect, the stabilization components may include the following property: absorption of water, such that the volatile organic liquid chemical component is included of less than 1% water. In some embodiments of this third aspect, the stabilization components may include hygroscopic salts. In some further embodiments of this third aspect, the hygroscopic salts include calcium chloride, calcium sulfate, magnesium sulfate, potassium sulfate, or sodium sulfate. In some embodiments of this third aspect, the stabilization components are added to the volatile organic liquid chemical component.

In some embodiments of this third aspect, the preservation component may include a denaturant chemical component that prevents degradation of analytes, such as DNA or RNA, within the tissue sample. In some further embodiments of this third aspect, the preservation components include a chaotropic agent. In some other further embodiments of this third aspect, the preservation components include an RNase inhibitor. In some further embodiments of this third aspect, the RNase inhibitor is Ribonucleoside Vanadyl Complex.

In some embodiments of this third aspect, the image color adjusting moiety includes a chemical dye. In some embodiments of this third aspect, the image color adjusting moiety includes chemical dyes, such as the class of Fast Dyes. In some embodiments of this third aspect, the image color adjusting moiety includes a chemical dye within the 600-650 nm wavelength.

In some embodiments of this third aspect, the visualization fluid composition is applied to the tissue by a tear-top squeeze applicator. In some further embodiments of this third aspect, the tear-top squeeze applicator may include one or more of the following properties: (i) a material that is inert to degradation via the volatile organic liquid chemical component, (ii) a bulb or dropper region in which the volatile organic liquid chemical component and stabilization components are sealed, is able to be opened without special tools, and (iii) a sufficient volatile organic liquid chemical component to wet at least one histological tissue section. In some further embodiments of the third aspect, the tear-top squeeze applicator includes a plastic pouch with a tear-off or twist-off seal. In some other further embodiments of the third aspect, the tear-top squeeze applicator includes a dropper that is used to directly apply the volatile organic liquid chemical component to a tissue surface after a seal is removed. In some other further embodiments of the third aspect, the tear-top squeeze applicator includes a filter paper or filter between a bulb containing the liquid and a dispensing spout to avoid dispensing any stabilization components, if insoluble in the volatile organic liquid chemical component, onto the tissue surface. In some embodiments of this third aspect, the applicator is made of a material that is inert to degradation by the composition or components thereof

In some embodiments of this third aspect, the visualization fluid composition is applied to the tissue by automated robotic mechanisms. In some embodiments of this third aspect, the visualization fluid composition is applied to the tissue by a user.

In some embodiments of this third aspect, the operator is a human user or a robot. In some embodiments of this third aspect, step (c) of the method is conducted without further direct visual inspection of the sample. In some further embodiments of this third aspect, step (c) of the method includes combining the images from step (b) with normalization techniques to modify the image. In some further embodiments of this third aspect, the normalization technique includes histogram stretching. In some further embodiments of this third aspect, the normalization technique includes white balancing.

In some other further embodiments of this third aspect, step (c) of the method includes subjecting the images from step (b) to machine-learning software to identify the regions of interest. In some further embodiments of this third aspect, the resulting marked-up image is sent electronically to a receiver. In some further embodiments of this third aspect, the receiver is a user. In some other further embodiments of this third aspect, the receiver is a machine, such as an automated or manually operable device. In some embodiments of this third aspect, step (e) includes (i) placing a thin UV-permeable thermo-polymer microdissection film or coverslip with embedded near-UV absorbing dye on top of the sample, (ii) using a near-UV flash computer system to mask regions of the sample that are not regions of interest, and (iii) microdissecting regions of the sample that are not masked onto the microdissection film or coverslip. In some further embodiments of the third aspect, the method includes further analyzing the regions of the sample that have been microdissected onto the microdissection film or coverslip.

In a fourth aspect, the present disclosure provides a composition tunable for laser capture microdissection using infrared and near-UV lasers, the composition includes one or more of the following: a) a compound that efficiently captures back-scattered laser light, b) a compound that efficiently captures back-scattered laser light and does not discharge the energy as heat, and c) a compound that efficiently captures back-scattered laser light and discharges this energy as heat. In some embodiments of this fourth aspect, the compound that efficiently captures back-scattered laser light exhibits low absorbance directly at 405 nm. In some embodiments of this fourth aspect, the compound that efficiently captures back-scattered laser light and does not discharge the energy as heat exhibits high absorption at 405 nm but low discharge of this energy as heat. In some embodiments of this fourth aspect, the compound that efficiently captures back-scattered laser light and discharges this energy as heat exhibits high absorption at 405 nm and primarily discharges this energy as heat. In some embodiments, the compound that efficiently captures back-scattered laser light includes 2-(2H-Benzotriazol-2-yl)-4-(1,1,3,3-tetramethylbutyl)phenol. In some embodiments of this fourth aspect, the compound that efficiently captures back-scattered laser light and does not discharge this energy as heat includes Sodium 4-[[4-[benzyl(ethyl)amino]phenyl]azo]-2,5-dichlorobenzenesulphonate. In some embodiments of this fourth aspect, the compound that efficiently captures back-scattered laser light and discharges this energy as heat includes 2-tert-Butyl-6-(5-chloro-2H-benzotriazol-2-yl)-4-methylphenol. In some embodiments of this fourth aspect, the composition includes sodium 4-[[4-[benzyl(ethyl)amino]phenyl]azo]-2,5-dichlorobenzenesulphonate, 2-(2H-Benzotriazol-2-yl)-4-(1,1,3,3-tetramethylbutyl)phenol, and 2-tert-Butyl-6-(5-chloro-2H-benzotriazol-2-yl)-4-methylphenol. In some embodiments of this fourth aspect, the composition includes 2-(2H-Benzotriazol-2-yl)-4-(1,1,3,3-tetramethylbutyl)phenol, 2-tert-Butyl-6-(5-chloro-2H-benzotriazol-2-yl)-4-methylphenol, and 2-(2-Hydroxy-5-methylphenyl)benzotriazole. In some embodiments of this fourth aspect, the compound is incorporated with poly(ethylene-co-vinyl acetate), vinyl acetate 40 wt. %. In some embodiments of this fourth aspect, the compound is incorporated with an ethanol, ethyl acetate, or ethyl formate solution.

Various embodiments may utilize the equipment, compositions and techniques disclosed in U.S. patent application Ser. No. 16/036,283, filed May 10, 2023, and U.S. Pat. No. 10,697,866, granted Jun. 30, 2020, the entire contents of which are hereby incorporated by reference, including for the embodiments shown therein of the aforementioned equipment, compositions and techniques.

### BRIEF DESCRIPTION OF THE DRAWINGS

The patent or application file contains at least one drawing executed in color. Copies of this patent or patent application publication with color drawing(s) will be provided by the Office upon request and payment of necessary fee.

FIGS. 1A, 1B, and 1C shows a schematic outlining the current problems in the field, the solution offered, and the results of said solution.

FIG. 2 shows an illustrated view of the use of the claimed composition and methods of use.

FIG. 3 shows an illustrated overview of the near-UV laser flash system.

FIG. 4 shows a histogram depicting the spot size and capture results from various microdissection systems.

FIGS. 5A, 5B, 5C, and 5D depict the chemical structures of various disclosed low molecular weight ester, ether, or formate moieties. FIG. 5A is the chemical structure for ethyl acetate. FIG. 5B is the chemical structure for methyl acetate. FIG. 5C is the chemical structure for propyl acetate. FIG. 5D is the chemical structure for butyl acetate.

FIGS. 6A, 6B, 6C, and 6D depict the chemical structures of additional various disclosed low molecular weight ester, ether, or formate moieties. FIG. 6A is the chemical structure for methyl formate. FIG. 6B is the chemical structure for ethyl formate. FIG. 6C is the chemical structure for propyl formate. FIG. 6D is the chemical structure for butyl formate.

FIGS. 7A and 7B show the same breast cancer lung metastasis lesion. FIG. 7A is the lesion visualized with a coverslip. FIG. 7B is the lesion visualized with visualization fluid composition.

FIGS. 8A and 8B show the same ductal carcinoma in situ (DCIS) lesion. FIG. 8A is the lesion visualized without a coverslip. FIG. 8B is the lesion visualized with visualization fluid composition.

FIGS. 9A, 9B, 9C, and 9D depict tissues visualized with visualization fluid composition. FIGS. 9A and FIG. 9C are both images of samples from the breast duct. FIGS. 9B and FIG. 9D are both images of samples from DCIS.

FIGS. 10A, 10B, 10C, 10D, 10E, 10F, and 10G show comparisons of tissues visualized with a coverslip, with ethanol alone, or with ethanol and additional compounds. FIG. 10A depicts tissue visualized with a coverslip. FIGS. 10B-10D show tissues visualized with ethanol alone. FIG. 10E shows the tissue visualized with 80% ethanol and 20% acetonitrile. FIG. 10F shows the tissue visualized with 80% ethanol and 20% THF. FIG. 10G shows the tissue visualized with 80% ethanol and 20% ethyl acetate.

FIGS. 11A and 11B show images of ductal carcinoma with hematoxylin and eosin (H&E) staining and visualized with visualization fluid composition including 30% ethyl acetate and 70% ethanol.

FIGS. 12A and 12B depict images of a blood smear visualized with visualization fluid composition including 30% ethyl acetate and 70% ethanol.

FIGS. 13A and 13B show images of a lung tumor metastasis with immunohistochemistry and peroxidase staining as visualized with visualization fluid composition including 30% ethyl acetate and 70% ethanol.

FIGS. 14A and 14B depict images of a comido carcinoma breast lesion. FIG. 14A shows the sample visualized without visualization fluid composition. FIG. 14B shows the sample visualized with visualization fluid composition.

FIGS. 15A, 15B, 15C, and 15D show various tissues visualized with or without visualization composition. FIG. 15A is a cribriform carcinoma breast lesion visualized without visualization fluid composition. FIG. 15B is the same cribriform carcinoma breast lesion visualized with visualization fluid composition. FIG. 15C is a DCIS lesion visualized without visualization fluid composition. FIG. 15D is the same DCIS lesion visualized with visualization fluid composition.

FIGS. 16A, 16B, 16C, 16D, 16E, 16F, 16G, and 16H show a DCIS lesion visualized in two different magnifications with visualization fluid compositions with different concentrations of ethyl acetate. FIGS. 16A, 16C, 16E, and 16G were taken with 20× magnification. FIGS. 16B, 16D, 16F, and 16H were taken with 4× magnification. FIGS. 16A-16B show visualization of the sample with a visualization fluid composition with 10% ethyl acetate. FIGS. 16C-16D show visualization of the sample with a visualization fluid composition with 20% ethyl acetate. FIGS. 16E-16F show visualization of the sample with a visualization fluid composition with 30% ethyl acetate. FIGS. 16G-16H show visualization of the sample with a visualization fluid composition with 40% ethyl acetate.

FIGS. 17A and 17B depict the same lesion visualized with visualization fluid compositions with different concentrations of ethyl acetate. FIG. 17A shows the lesion visualized with visualization fluid composition with 10% ethyl acetate. FIG. 17B shows the lesion visualized with visualization fluid composition with 30% ethyl acetate.

FIGS. 18A, 18B, 18C, and 18D show DCIS lesions visualized in 40× and 100× magnification with visualization fluid composition including 30% ethyl acetate. FIG. 18A and FIG. 18C show images of samples taken at 40× magnification. FIG. 18B and FIG. 18D show images of samples taken at 100× magnification.

FIGS. 19A, 19B, 19C, and 19D show images of the same lesion visualized with visualization fluid compositions including 30% ethyl acetate and 70% ethanol. FIG. 19A depicts the lesion visualized without a dye. FIGS. 19B-19D depict the lesion visualized with the dye.

FIGS. 20A, 20B, and 20C show the same DCIS lesion. FIG. 20A shows the lesion visualized using a coverslip. FIG. 20B shows the same lesion visualized without using a coverslip. FIG. 20C shows the same lesion visualized with the visualization fluid composition and without using a coverslip.

FIGS. 21A and 21B show the same DCIS lesion. FIG. 21A shows the lesion visualized without using a coverslip. FIG. 21B shows the same lesion visualized with visualization fluid composition and without using a coverslip.

FIGS. 22A, 22B, 22C, 22D, 22E, 22F, 22G, and 22H show images of a first breast cancer sample using visualization fluid composition including 30% ethyl acetate and 70% ethanol. FIGS. 22A-22D show the sample visualized with the visualization fluid composition. FIGS. 22E-22H show the sample visualized without the visualization fluid composition.

FIGS. 23A, 23B, 23C, 23D, 23E, 23F, 23G, and 23H depict images of a second breast cancer sample using visualization fluid composition including 30% ethyl acetate and 70% ethanol. FIGS. 23A-23D show the sample visualized with the visualization fluid composition. FIGS. 23E-23H show the sample visualized without the visualization fluid composition.

FIGS. 24A, 24B, 24C, 24D, 24E, 24F, 24G, and 24H show images of a third breast cancer sample using visualization fluid composition including 30% ethyl acetate and 70% ethanol. FIGS. 24A-24D show the sample visualized with the visualization fluid composition. FIGS. 24E-24H show the sample visualized without the visualization fluid composition.

FIGS. 25A, 25B, 25C, 25D, 25E, 25F, 25G, and 25H depict images of a fourth breast cancer sample using visualization fluid composition including 30% ethyl acetate and 70% ethanol. FIGS. 25A-25D show the sample visualized with the visualization fluid composition. FIGS. 25E-25H show the sample visualized without the visualization fluid composition.

FIG. 26 shows a nucleus captured from a DCIS sample.

FIG. 27 shows a DCIS region captured using visualization fluid composition and dye.

FIGS. 28A, 28B, 28C, 28D, 28E, 28F, 28G, 28H, 28I, 28J, 28K, and 28L depict the absorption spectra for compounds that may be included in the composition tunable for laser capture microdissection using infrared and near-UV lasers.

FIGS. 29A, 29B, and 29C show that a visualization fluid composition with UV absorbing dye aids low-power, single-cell microdissection. FIG. 29A shows microdissection with visualization fluid composition only. FIG. 29B shows microdissection with visualization fluid composition and dye. FIG. 29C shows microdissection without visualization fluid composition and dye.

FIG. 30 shows a graph of the relative spot size using visualization fluid composition with and without dye.

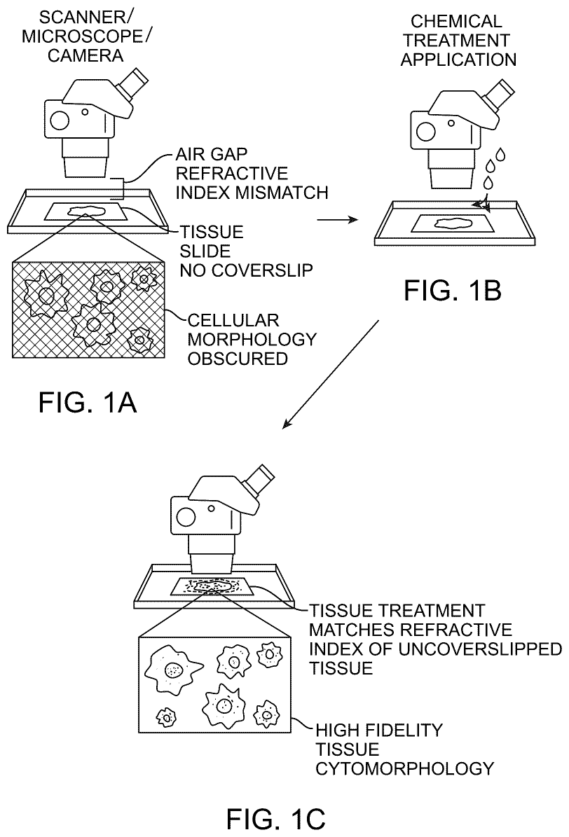

### DETAILED DESCRIPTION OF THE DRAWINGS

The present disclosure relates to a class of volatile organic compounds that provide outstanding visualization of an unstained tissue, equivalent to or superior to a cover-slipped tissue section, and is used for fluorescent, immunohistochemical, or non-stained tissue for diagnostic interpretation and tissue capture or sampling procedures. Herein are described embodiments for a visualization fluid employing a newly identified class of chemical components to further improve visualization and downstream processing. To visualize the tissue prepared for microdissection, the visualization fluid used in conjunction with an image processing software to remove, enhance, or mask pixels of the digitized tissue slide image based on wavelength or intensity. Chemistry additives to the visualization chemistry can be included to enhance or suppress selected wavelengths for absorbance or emission. Beyond a novel composition of matter visualization chemistry, the present disclosure shows how this chemistry is the starting point for an integrated digital telepathology workflow solution in which the diagnostic information is displayed back on the actual tissue digital histologic image. As such, the present disclosure permits digital image capture at high fidelity and resolution that may be integrated directly into automate molecular analysis of the same tissue without interference of the diagnostic workflow or diagnostic accuracy, thus overcoming deficiencies in the field, as the visualization chemistry is volatile and thus does not interfere with any subsequent analyses.

It is to be appreciated that certain aspects, modes, embodiments, variations and features of the present methods are described below in various levels of detail in order to provide a substantial understanding of the present technology. It is to be understood that the present disclosure is not limited to particular uses, methods, compounds, compositions or biological systems, which can, of course, vary. It is also to be understood that the terminology used herein for the purpose of describing particular embodiments only and is not intended to be limiting.

### I. Definitions

To facilitate an understanding of the present disclosure, a number of terms and phrases are defined below. Unless otherwise noted, technical terms are used according to conventional usage.

As used herein, the terms “about” and “approximately,” when used to modify a number value or numeric range, indicate the deviations of 5% to 10% above and 5% to 10% below the value or range remain within the intended meaning of the recited value or range.

The term “chaotropic agent,” as used herein, refers to a substance which increases the entropy of the system by interfering with intramolecular interactions mediated by non-covalent forces such as hydrogen bonds, van der Waals forces, and hydrophobic effects. Chaotropic agents can decrease the net hydrophobic effect of hydrophobic regions because of a disorder of water molecules adjacent to the protein. This solubilizes the hydrophobic region in the solution and may, in some cases, denature a protein. Chaotropic agents may shield charges and prevent the stabilization of salt bridges. Thus, a “chaotropic agent” as used herein is a molecule that, when dissolved in water, can disrupt the hydrogen bonding network between water molecules (i.e., exerts chaotropic activity). This influences the stability of the native state of other molecules in the solution, mainly macromolecules (proteins, nucleic acids) by weakening the hydrophobic effect. For example, a chaotropic agent reduces the amount of order in the structure of a protein formed by water molecules, both in the bulk and the hydration shells around hydrophobic amino acids and may cause its denaturation.

“Component,” as used herein, is a substance used for the purpose of detecting, measuring, examining, analyzing, and/or preserving the sample. This term includes both organic and inorganic components.

“High fidelity,” as used herein, refers to high quality images of the analyzed sample with distortion less than 5%, such as less than 4%, less than 3%, less than 1%, less than 0.5%, less than 0.1% or less of the original image of the sample.

“High throughput,” as used herein, is the use of automated equipment to rapidly test or analyze large numbers of samples varying from hundreds to millions of samples for biological activity at the model organism, cellular, pathway, or molecular level. Because high throughput methods typically aim to screen thousands of samples per day, they may possess automation-compatible assay designs, robotic-assisted sample handling, and/or automated data processing.

“Interference,” as used herein, is broadly defined as property to interfere in processing, analyzing, or examining of the sample at any given stage. An interference may be a substance, other than the assayed material or sample, which can be measured by the chosen analytical method or that can prevent the assayed material or sample from being measured. Interferences cause erroneous analytical results.

“Molecular analysis,” as used herein, is defined as a process governed by one or various techniques for analysis and identification of molecules, such as nucleic acids, amino acids, peptides, proteins, polymers, or biological markers in the genome and proteome as known to a person skilled in the art. This includes but is not limited to proteomic analysis (such as protein profiling), genetic analysis (such as individual's genetic code and how their cells express their genes as protein), RNA profiling, identification of cell type in a tissue sample, etc. Molecular analysis is also defined as molecular profiling. “Downstream molecular analysis,” as used herein, refers to further analytical study done on the sample after preselection or common procedure. For example, but not limited to, selection of regions of interest is followed by molecular analysis of that region of interest.

“Preservation,” as used herein, is broadly defined as a process to prevent the degradation of samples. As used herein, preservation may employ various denaturant chemical components, such as but not limited to a strong acid (such as acetic acid, trichloroacetic acid, sulfosalicylic acid) or a base (such as sodium hydroxide, sodium bicarbonate) or a concentrated inorganic salt or an organic solvent (such as ethanol, formaldehyde, glutaraldehyde) or a chaotropic agent (such as urea, guanidium chloride, lithium perchlorate, sodium dodecyl sulfate) or a disulfide bond reducer (such as 2-mercaptoethanol, dithiothreitol, TCEP) or a chemically reactive agent (such as hydrogen peroxide, elemental chlorine, hypochlorous acid, bromine, bromine water, iodine, nitic, oxidizing acids), etc.

“Refractive index matching,” as used herein, is a solution being adapted for optically clearing tissue samples of a particular type of tissue by determining the refractive index (RI) of this tissue type empirically or by literature study.

“Region of interest (ROI),” as used herein, is broadly defined as a sub-portion of a sample that is desired for study, analysis, and/or examination from the sample. The sub-portion can include a cell, cellular organelle, subcellular element, or a biomolecule (such as a protein or nucleic acid). The ROI is sometimes, though not always, spread throughout the biological sample but is characterized by a common physiochemical or biological property (such as recognition by a specific binding agent) that allows the target to be specifically recognized in the biological sample.

The term “sample” as used herein is used in its broadest sense and includes environmental and biological samples. Environmental samples include material from the environment such as soil and water. Biological samples may be animal (e.g., human), fluid (e.g., blood, plasma, serum, urine, saliva), solid (e.g., stool), tissue, liquid foods (e.g., milk), and solid foods (e.g., vegetables). For example, a pulmonary sample may be collected by broncho-alveolar lavage (BAL), which includes fluid and cells derived from lung tissues. Other examples of biological samples may include a cell, tissue extract, body fluid, chromosomes or extrachromosomal elements isolated from a cell, genomic DNA, RNA, cDNA, and the like. Samples may also include tissue sample.

“Stabilization,” as used herein, can be broadly defined as a process to retain structural and functional integrity and activity of the sample.

“Tissue sample” as used herein is a piece of tissue removed from an organism, e.g., a biopsy, or a whole organ of an organism or even a whole organism.

As used in the present disclosure and claims, the singular forms “a,” “an” and “the” include the plural forms unless the context clearly dictates otherwise. For example, reference to “a cell” includes a combination of two or more cells, and the like.

The terms “comprising,” “including,” “having” and the like, as used with respect to embodiments, are synonymous. It is understood that wherever embodiments described herein with the language “comprising,” otherwise analogous embodiment described in terms of “consisting of” and/or “consisting essentially of” are also provided.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

For the purpose of the description, a phrase in the form “A/B” or in the form “A and/or B” means (A), (B) or (A and B). For the purposes of the description, a phrase in the form “at least one of A, B, and C” means (A), (B), (C), (A and B), (A and C), (B and C) or (A, B and C).

The description may use the terms “embodiment” or “embodiments,” which may refer to one or more of the same or different embodiments unless indicated otherwise by context.

### II. Visualization Fluid Composition

The novel composition of matter visualization chemistry preserves RNA in the tissue and contains dyes to tune the absorbance and emission of selected wavelength of electromagnetic energy. Rapid degradation of RNA in the open tissue section undergoing analysis severely hampers RNA yield for molecular analysis for any existing technology. Conventional RNA preservative (e.g., RNA Later) damage morphology and are not volatile, thus interfering with the analysis.

The visualization fluid composition of matter for tissue visualization may include one or more of the following elements: a) a low molecular weight ester or ether moiety, b) a volatile organic liquid chemical component, c) stabilization components, d) preservation components, and e) an image color adjusting moiety. The visualization fluid composition improves the optical visualization of histologic tissue sections under microscopic evaluation and preserves tissue analytes for histological inspection by immunostaining, fluorescent staining, and chemical staining and for microdissection of histological tissue sections. The visualization fluid composition may be housed in a sealed container that is impermeable to water vapor for direct application of the solution to a slide. The container housing the visualization fluid composition may be integrated into a dispensing method such as a tear-top squeeze applicator for single use application into a tissue slide. The visualization fluid composition may be applied by robotic mechanisms to allow for high throughput scanning and visualization of multiple slides at one time.

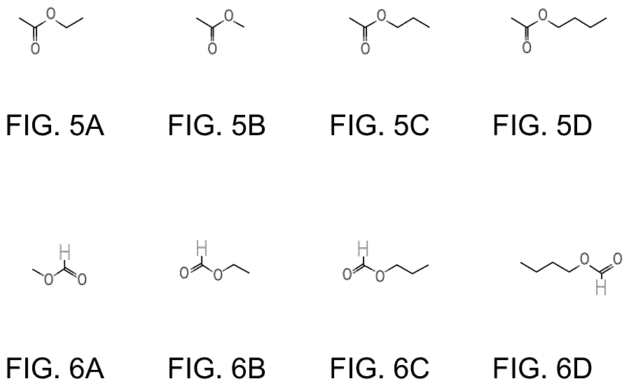

The low molecular weight ester, ether, or formate moiety may exhibit one or more of the following properties: a) a refractive index between 1.3-1.5, b) optical clarity defined as greater than 90% transmittance of incident light of the range of 400-800 nm, c) a vapor pressure between 5-25 kPa at room temperature (about 22° C.), and d) less than 1% water content (anhydrous). The low molecular weight ester, ether, or formate moiety further may not interfere with molecular analytes within the sample tissue or with the microdissection process. The low molecular weight ester, ether, or formate moiety may be a short-chain organic acetate compound, such as ethyl acetate, methyl acetate, propyl acetate, butyl acetate, or any isomer or combination of isomers thereof (FIGS. 5A-5D). The low molecular weight ester, ether, or formate moiety may be a short-chain organic formate compound, such as methyl formate, ethyl formate, propyl formate, butyl formate, or any isomer or combination of isomers thereof (FIGS. 6A-6D). The low molecular weight ester, ether, or formate moiety can be a mixture of a short-chain acetate compound and a short-chain formate compound.

The volatile organic liquid chemical component may exhibit one or more of the following properties: a) a refractive index between 1.3-1.5, b) optical clarity defined as greater than 90% transmittance of incident light of the range of approximately 400 to approximately 800 nm, c) a vapor pressure between approximately 5 to approximately 25 kPa at room temperature (about 22° C.), and d) less than 1% water content (anhydrous). The volatile organic liquid chemical component further may not interfere with molecular analytes within the sample tissue or with the microdissection process. The volatile organic liquid chemical component may be a short-chain alcohol solvent, such as methanol, ethanol, propanol, or any isomer or combination of isomers thereof. The volatile organic liquid chemical component may be a mixture of short-chain alcohol solvents, including methanol, ethanol, propanol, or any isomer or combination of isomers thereof. The volatile organic liquid chemical component may be acetonitrile. The volatile organic liquid chemical components may be a mixture of a) short-chain alcohol solvents, including methanol, ethanol, propanol, and any isomer or combination of isomers thereof, and b) acetonitrile. The volatile organic liquid chemical component can be a mixture of a) short-chain acetate compounds, including ethyl acetate, methyl acetate, propyl acetate, butyl acetate, and any isomer or combination of isomers thereof, and b) short-chain formate compounds, including ethyl formate, methyl formate, propyl formate, butyl formate, and any isomer or combination of isomers thereof.

The stabilization components can exhibit absorption of water, such that the volatile organic liquid chemical component includes less than 1% water. The stabilization components may be hygroscopic salt, such as calcium chloride, calcium sulfate, magnesium sulfate, potassium sulfate, or sodium sulfate. The stabilization components can be added to the volatile organic liquid chemical component.

The preservation component may be a denaturant chemical component that prevents degradation of analytes, such as DNA or RNA, within the tissue sample. The preservation components can be a chaotropic agent. The preservation components can be an RNase inhibitor, such as Ribonucleoside Vanadyl Complex.

The image color adjusting moiety may be a chemical dye, such as the class of Fast Dyes. The image color adjusting moiety can be a chemical dye within the 600-650 nm wavelength.

The visualization fluid composition can be applied to the tissue by a tear-top squeeze applicator. The tear-top squeeze applicator may: a) be made of a material that is inert to degradation via the volatile organic liquid chemical component, b) include a bulb or dropper region in which the volatile organic liquid chemical component and stabilization components are sealed, c) be able to be opened without special tools, and d) contain sufficient volatile organic liquid chemical component to wet at least one histological tissue section. The tear-top squeeze applicator can be a plastic pouch with a tear-off or twist-off seal. The tear-top squeeze applicator can also be a dropper that is used to directly apply the volatile organic liquid chemical component to a tissue surface after a seal is removed. The tear-top squeeze applicator may include a filter paper or filter between a bulb containing the liquid and a dispensing spout to avoid dispensing any stabilization components, if insoluble in the volatile organic liquid chemical component, onto the tissue surface.

The visualization fluid composition can be applied to the tissue by automated robotic mechanisms or by a user.

### III. Method of Visualizing Tissue Using the Visualization Fluid Composition

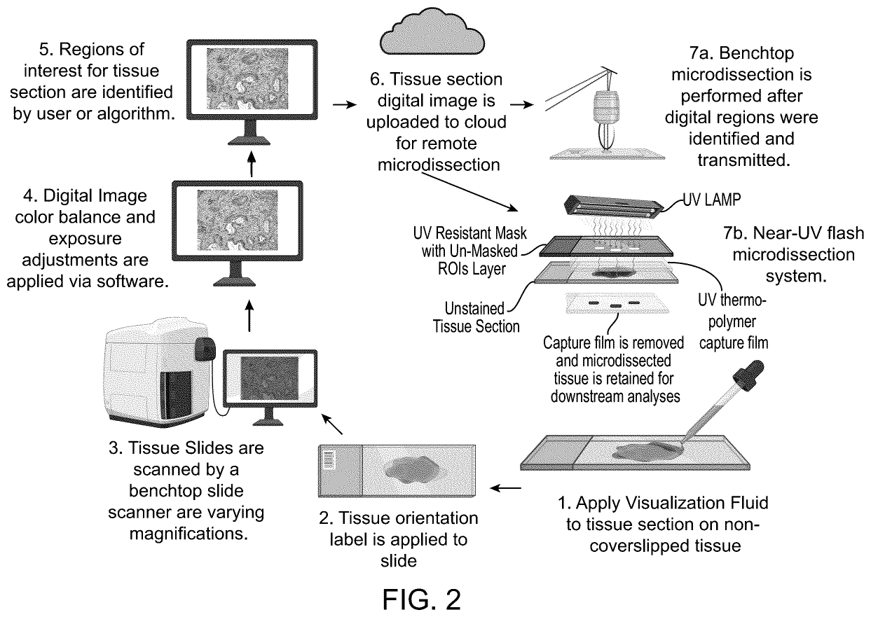

The present disclosure also provides a method of visualizing tissue using the visualization fluid composition which has the following steps: (a) application of the visualization fluid composition onto a sample mounted onto a slide by an operator, (b) scanning and imaging the slide digitally, optically, and/or microscopically, (c) analyzing the images of the slides to identify a region of interest, and (d) molecular analysis of the regions of interest (FIG. 2). The visualization fluid composition can be any composition as described above.

The operator can be a human user or a robot. Step (c) of the method may be conducted without further direct visual inspection of the sample. Step (c) of the method may involve combining the images from step (b) with normalization techniques to modify the image.

The images generated from visualizing the sample can be further processed using various normalization software and programs. The images be processed to modify the color balance, exposure, and contrast. One such normalization program is histogram stretching. Through quantification of the intensity of a histological image, a histogram is constructed which maps the intensity values of each pixel from 0 to 255 in red, green, and blue (RGB). The color (RGB) digital image used contains a range of values less than 255; values at the extremes of the scale are excluded to provide improved contrast to the image. This is achieved through assigning new intensity values to the pixels using the following equation:

$$g ( x , y ) = \frac{f ( x , y ) - 0}{225 - 0} \times 255.$$

White balancing is another technique used in imaging processing and image analysis. White balance adds a filter by selecting a white region in the image and adjusting the pixel values to a “true white.” In a color digital image using red, green, and blue, “true white” is the value 255, 255, 255. The date from the selected pixel will multiple the red, green, and blue values to get 255, 255, 255. The multiplication factors are then applied to the entire image to receive a white balanced image, resulting in better visualization and contrast. White balancing may be achieved during the image processing or afterwards through image processing.

Step (c) of the method may include subjecting the images from step (b) to machine-learning software to identify the regions of interest. The operator marks up the regions of analytical or diagnostic interest directly on the digital image. The regions of interest are referenced to fiducial marks on the slide. The resulting marked-up image may be sent electronically to a receiver, which may be a user or a machine, such as an automated or manually operable device. Such a device may be a microsampling instrument. The microsampling instrument procures the regions of interest for any type of molecular analysis.

In step (d), the molecular analysis of each region of interest is sent to the user, permitting them to click on the marked-up digital image to receive the results for that specific region. Moreover, the user or a computer algorithm can identify the regions of interest in the non-cover-slipped tissue treated with the visualization fluid composition for microdissection within the scanned image and without the requirement of microscopic visualization and then transmit all this information to a cloud for storage. At a later point in time, a separate benchtop microsampler that does not require optical or microscopic operation by the user can remotely and automatically dissect or microsample the slide tissue, including single cells or multiple cells, based on the transmitted direction from the cloud (FIG. 2). This does not rely on a conventional microscope to view the regions of interest but rather a benchtop slide scanner for high throughput digitization. A benchtop laser system can perform the microdissection of the tissue regions of interest separately from the viewing of the tissue. The separation of the microscope from the laser or microsampling technology can greatly improve the efficiency of performing pathological analysis. These steps may be performed by a robotic system to improve precision and speed. Such a robotic system may be controlled by a controller having a memory and a processor configured to carry out instructions stored in the memory to control the robotic system to carry out the aforementioned steps.

The method can include an additional step (e), which is microdissection or microsampling of the regions of interest based on the result of the molecular analysis, wherein there is no further requirement for optical or microscopic visualization of the sample.

### IV. Method of Visualizing Tissue Using the Visualization Fluid Composition and Microdissecting Using a Near-UV Flash System

The present disclosure also provides a method of visualizing tissue using the visualization fluid composition, which has the following steps: (a) application of the visualization fluid composition onto a sample mounted onto a slide by an operator, b) scanning and imaging the slide digitally, optically, and/or microscopically, c) analyzing the images of the slides to identify a region of interest, d) molecular analysis of the regions of interest, and (e) microdissection of the sample using a near-UV laser flash system (FIG. 2). The visualization fluid composition can be any composition as described above. The steps (a)-(d) can be the same as those described above.

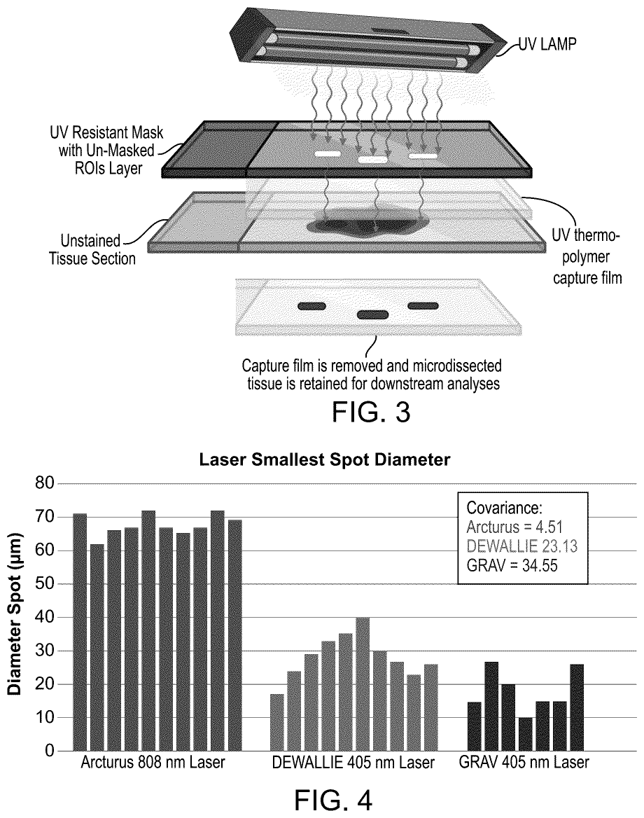

Step (e) includes (i) placing a thin UV-permeable thermo-polymer microdissection film or coverslip with embedded near-UV absorbing dye on top of the sample, (ii) using a near-UV flash computer system to mask regions of the sample that are not regions of interest, and (iii) microdissecting regions of the sample that are not masked onto the microdissection film or coverslip. (FIG. 3). The regions of the sample microdissected on the microdissection film or coverslip are analyzed. This method functions as the “masked” regions are resistant to the laser energy and remain of the initial slide.

### V. Composition Tunable for Laser Capture Microdissection Using Infrared and Near-UV Lasers

The present disclosure further provides a composition tunable for laser capture microdissection using infrared and near-UV lasers, the composition including one or more of the following: a) a compound that efficiently captures back-scattered laser light, b) a compound that efficiently captures back-scattered laser light and does not discharge the energy as heat, and c) a compound that efficiently captures back-scattered laser light and discharges this energy as heat. The composition can include three such compounds, i.e., a compound according to (a), a compound according to (b), and a compound according to (c) are provided. The composition of said near-UV and UV-absorbing compounds within the visualization fluid of within the capture surface improves the performance of the system for digital pathology, wherein the mixture of compounds prevents lateral propagation of the laser beam, enhances tissue-capture interface fusion via enhanced melting of the thermo-polymer capture interface (exothermic), and improves absorption in the region of 405 nm. A composition of near-UV and UV-absorbing compounds incorporated within the capture surface interface reduces laser capture interface polymer side laser propagation by incorporating back-scatter melt and increasing heat generation with lower laser energy input.

Compounds that efficiently capture back-scattered laser light may have low absorbance directly at 405 nm. Compounds selected for their inclusion efficiently capture back-scattered laser light due to their wide bandwidth of absorption, which ensures more of the laser light is effectively converted to heat to melt the thermo-polymer capture interface. These compounds may have low absorbance directly at 405 nm but wide absorption bands in this region. An exemplary compound that efficiently captures back-scattered laser light is 2-(2H-Benzotriazol-2-yl)-4-(1,1,3,3-tetramethylbutyl)phenol.

Compounds that efficiently capture back-scattered laser light and do not discharge the energy as heat can have high absorption at 405 nm but low discharge of this energy as heat. These compounds can help reduce unintended melting of the thermo-polymer outside the peak laser spot intensity to maintain a light beam with a narrow width for capture of single cells or small cell populations. These compounds may have high absorption at 405 nm but low discharge of this energy as heat. An exemplary compound that efficiently captures back-scattered laser light and does not discharge this energy as heat is sodium 4-[[4-[benzyl(ethyl)amino]phenyl]azo]-2,5-dichlorobenzenesulphonate.

Compounds that efficiently capture back-scattered laser light and discharge this energy as heat can have high absorption at 405 nm and primarily discharge this energy as heat. These compounds prevent the laser light from reaching the tissue surface, but instead use the laser energy to melt the thermo-polymer to the tissue surface that is desired for capture. These compounds can have high absorption at 405 nm and can primarily discharge this energy as heat. An exemplary compound that efficiently captures back-scattered laser light and discharges this energy as heat is 2-tert-Butyl-6-(5-chloro-2H-benzotriazol-2-yl)-4-methylphenol.

By combining compounds with properties in these three categories, improved performance of 405 nm laser capture can be achieved.

The composition can include sodium 4-[[4-[benzyl(ethyl)amino]phenyl]azo]-2,5-dichlorobenzenesulphonate, 2-(2H-Benzotriazol-2-yl)-4-(1,1,3,3 -tetramethylbutyl)phenol, and 2-tert-Butyl-6-(5-chloro-2H-benzotriazol-2-yl)-4-methylphenol. The composition can include 2-(2H-Benzotriazol-2-yl)-4-(1,1,3,3-tetramethylbutyl)phenol, 2-tert-Butyl-6-(5-chloro-2H-benzotriazol-2-yl)-4-methylphenol, and 2-(2-Hydroxy-5-methylphenyl)benzotriazole.

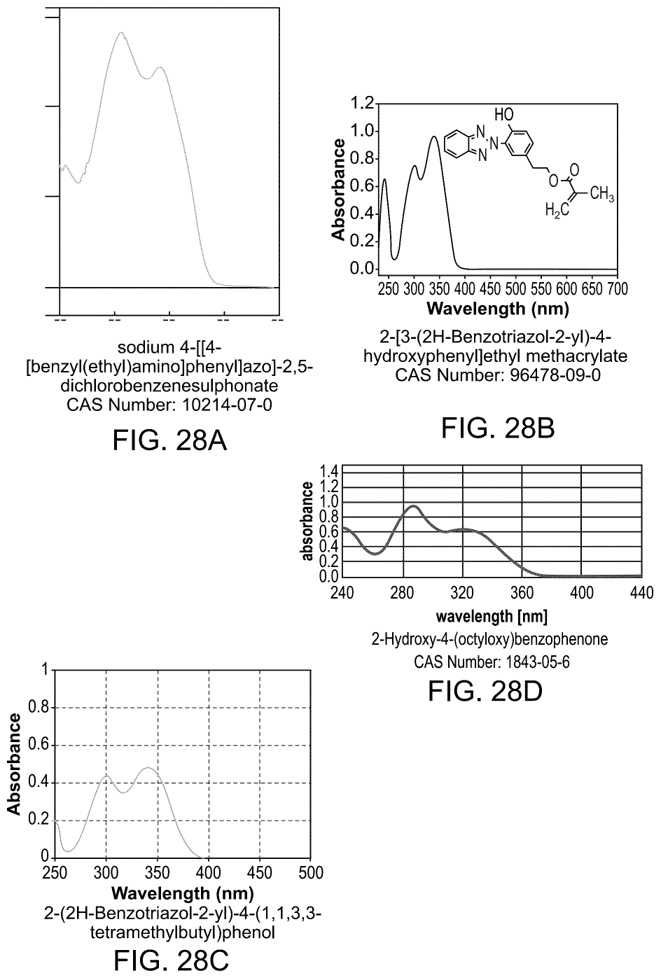

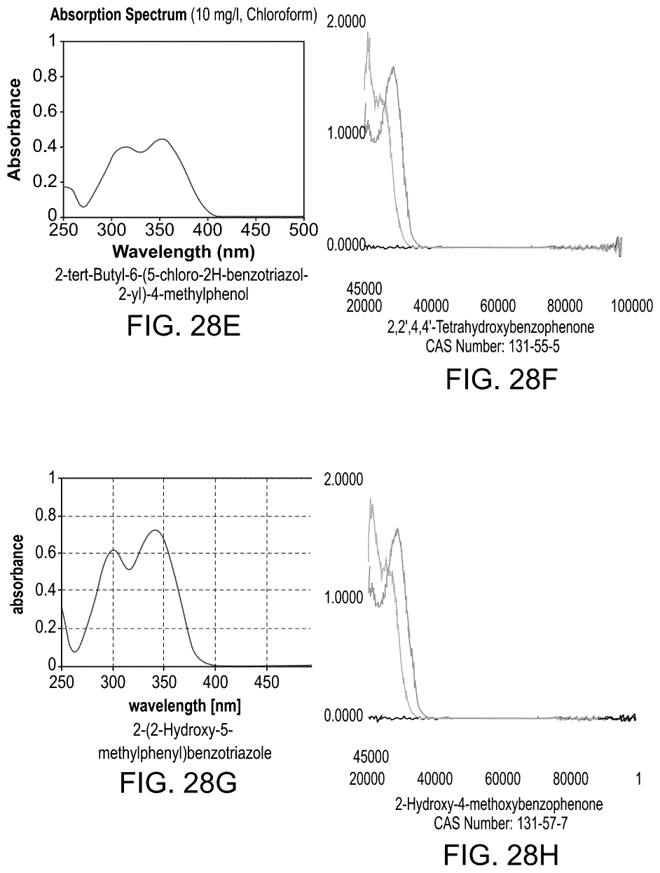

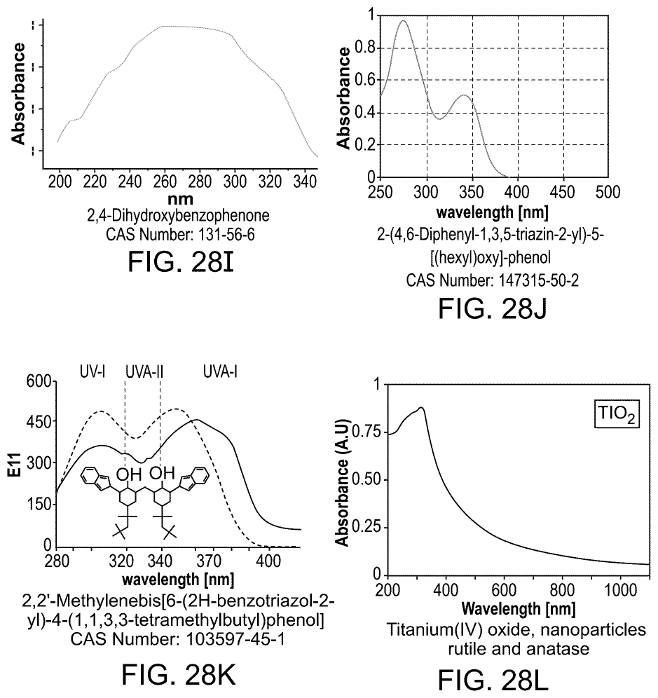

Classes of compound molecules which absorb UV energy (200-400 nm) to aid laser microdissection include but are not limited to: triazines, benzotriazoles, benzophenones, and oxalanilides. Potential compounds for use in the composition are disclosed but not limited to the compounds in Table 1 (see also FIGS. 28A-28L). These compounds are mixable to form the composition to improve tissue microdissection at the capture interface polymer surface.

TABLE 1

| | | Absorbance | |
|---|---|---|---|
| | | Spectra | Capacity for |
| | | (or λmax | absorbed |
| | | values) | light |
| | | (FIGS. 28A- | dissipation |
| Name | Structure | 28L) | as heat |
| sodium 4-[[4- [benzyl(ethyl)amino] phenyl]azo]-2,5- dichlorobenzenesul- phonate CAS Number: 10224-07-0 | 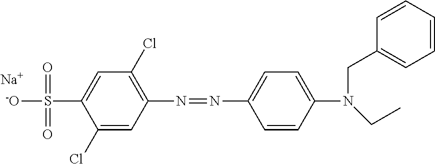 | Absorption maxima at 414 nm | Low |
| 2-(2H-Benzotriazol- 2-yl)-4-(1,1,3,3- tetramethylbutyl) phenol | 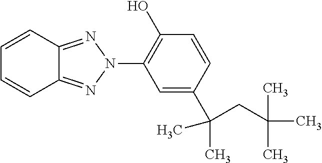 [SMILES: CC(C)(C)CC(C)(C)c1ccc(O)c(-n2nc3ccccc3n2)c1] | The absorption maxima are at 301 nm and 343 nm. | Medium |
| 2-tert-Butyl-6-(5- chloro-2H- benzotriazol-2-yl)- 4-methylphenol | 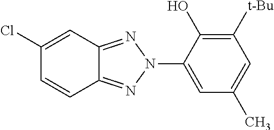 [SMILES: Cc1cc(-n2nc3ccc(Cl)cc3n2)c(O)c(C(C)(C)C)c1] | The absorption maxima are at 312 nm and 353 nm. | High |
| 2-(2-Hydroxy-5- methylphenyl) benzotriazole | 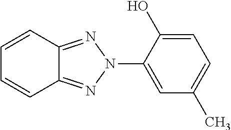 [SMILES: Cc1ccc(O)c(-n2nc3ccccc3n2)c1] | The absorption maxima are at 301 nm and 341 nm. | Low |
| 2,4- Dihydroxybenzo- phenone CAS Number: 131-56-6 | 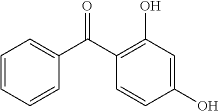 [SMILES: O=C(c1ccccc1)c1ccc(O)cc1O] | Absorbance: 290-400 nm. | Low |
| 2,2′- Methylenebis[6- (2H-benzotriazol-2- yl)-4-(1,1,3,3- tetramethylbutyl) phenol] CAS Number: 103597-45-1 | 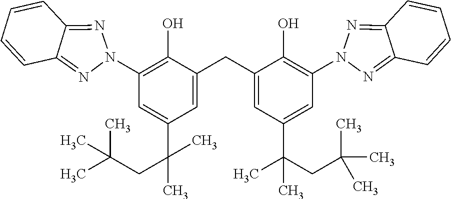 [SMILES: CC(C)(C)CC(C)(C)c1cc(Cc2cc(C(C)(C)CC(C)(C)C)cc(-n3nc4ccccc4n3)c2O)c(O)c(-n2nc3ccccc3n2)c1] | Absorbance: Broad UV absorbance in aqueous (solid) or organic (dioxane, dotted) solution | Low |
| 2-[3-(2H- Benzotriazol-2-yl)- 4- hydroxyphenyl] ethyl methacrylate CAS Number: 96478-09-0 | 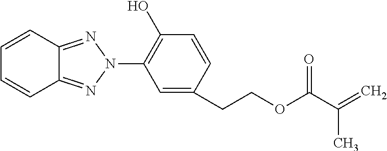 [SMILES: C=C(C)C(=O)OCCc1ccc(O)c(-n2nc3ccccc3n2)c1] | Absorbance: 300-400 nm | Not determined |
| 2-Hydroxy-4- (octyloxy)benzo- phenone CAS Number: 1843-05-6 | 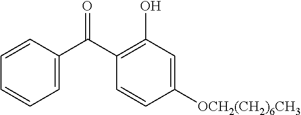 | Absorbance: 300-400 nm | Not determined |
| 2,2′,4,4′- Tetrahydroxybenzo- phenone CAS Number: 131-55-5 | 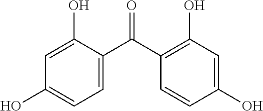 [SMILES: O=C(c1ccc(O)cc1O)c1ccc(O)cc1O] | Absorbance maxima at 375 nm (red trance) | Medium |
| 2-Hydroxy-4- methoxybenzo- phenone CAS Number: 131-57-7 | 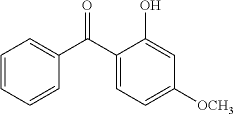 [SMILES: COc1ccc(C(=O)c2ccccc2)c(O)c1] | Absorbance: Absorbance maxima at 300 nm (yellow trace) | Not determined |
| 2-(4,6-Diphenyl- 1,3,5-triazin-2-yl)-5- [(hexyl)oxy]-phenol CAS Number: 147315-50-2 | 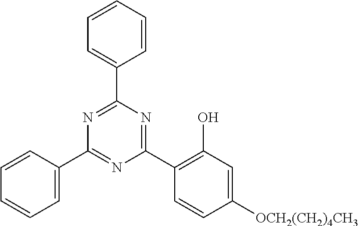 | The absorption maxima are at 274 nm and 341 nm. | Not determined |
| Titanium (IV) oxide, nanoparticles rutile and anatase | [symbol] | Absorbance: 300-400 nm | High |
| | [symbol] | | |
| | [symbol] | | |
| | [symbol] | | |
| | [symbol] | | |

Other combinations of compounds can be combined to fine tune performance based on expected use of the cap, including but not limited to enhancing recovery of tissue that is strongly adhere to slides, to enhancing recovery of very small cell populations, etc.

The compound may be incorporated with poly(ethylene-co-vinyl acetate), vinyl acetate 40 wt. %. To generate a mixture of the compounds within the tissue cap interface, the EVA polymer must be dissolved in xylene (for example, 10 mL xylene to 1 gram of EVA polymer). Next, a specific mixed weight of the compounds is homogenously dissolved into the polymer (for example but not limited to, 0.001 grams of compound added to the 10 mL of above dissolved polymer). A volume of the mixed polymer is deposited onto the tissue capture interface body. After the xylene in the polymer mixture is evaporated, the tissue capture interface body is molded to a desired shape under heat and allowed to cool. The tissue capture interface body is then placed on top of the tissue, and LCM is then performed. Other embodiments of generating the polymer with UV or near-UV absorbing compounds onto the capture interface body can include the creation of a gradient of exothermic compounds within the polymer to allow for varied tissue capture and heat generation and the use as a particulate which would excite and exhibit greater exothermic energy generation and melting qualities as compared to even diffusion with the polymer as discussed above.

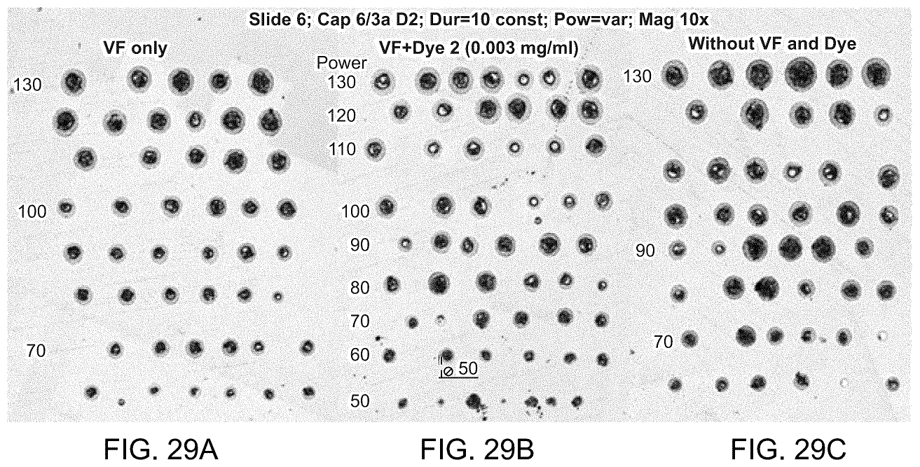

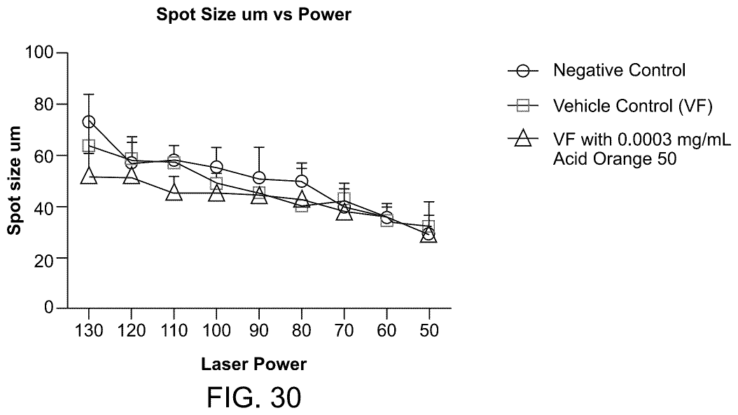

The compound may be incorporated with an ethanol, ethyl acetate, or ethyl formate solution. The compound may be included in a mixture with an ethanol, ethyl acetate, or ethyl formate solution (or related volatile organic acetates and formates as detailed above (see II. Visualization Fluid Composition above). This solution can be then applied to the open face tissue for instant tissue histomorphology visualization and inspection. The compound's inclusion at the tissue surface aids near-UV microdissection because it enhances capture efficiency, focal point capture precision, and light and heat energy transfer from the tissue to the capture interface surface for microdissection. The inclusion of dye to the visualization solution prevents the lateral propagation of the thermo-polymer upon laser excitation and allows for precise low area tissue microdissection (FIGS. 29A-29C and 30). Tissue visualization composition which contains an ethanol base with either ethyl acetate or ethyl formate solution aids laser capture microdissection with greater reproducibility in tissue shot quality (round, consistent diameters) and sensitivity at lower powers (FIG. 29A). The inclusion of exothermic compounds enhances the sensitivity and shot reproducibility (i.e., rounder and power level <60) (FIG. 29B). When no visualization fluid composition or exothermic compounds is added, laser capture microdissection generates variable shot qualities (jagged edges, varied diameters) and cannot achieve reproducible capture sensitivity below a power of 70 (FIG. 29C).

Thus, the combination of a near-UV (405 nm) laser microdissection energy source with a mixture of electromagnetic exothermic light-absorbing compounds incorporated either within the tissue capture interface thermo-polymer, which contains a vinyl acetate percentage between 25-40%, or as a tissue visualization solution to improve capture efficiency, focal point capture precision, and enhanced light and heat energy transfer. Within the tissue capture interface, incorporation of each compound can be between 0.0001 to 0.1 grams of compound per gram of EVA (0.01 to 10 wt. %). Average incorporation is within the range from 0.1-4%.

### EXAMPLES

The present technology is further illustrated by the following Examples, which should not be construed as limiting in any way.

### Example 1

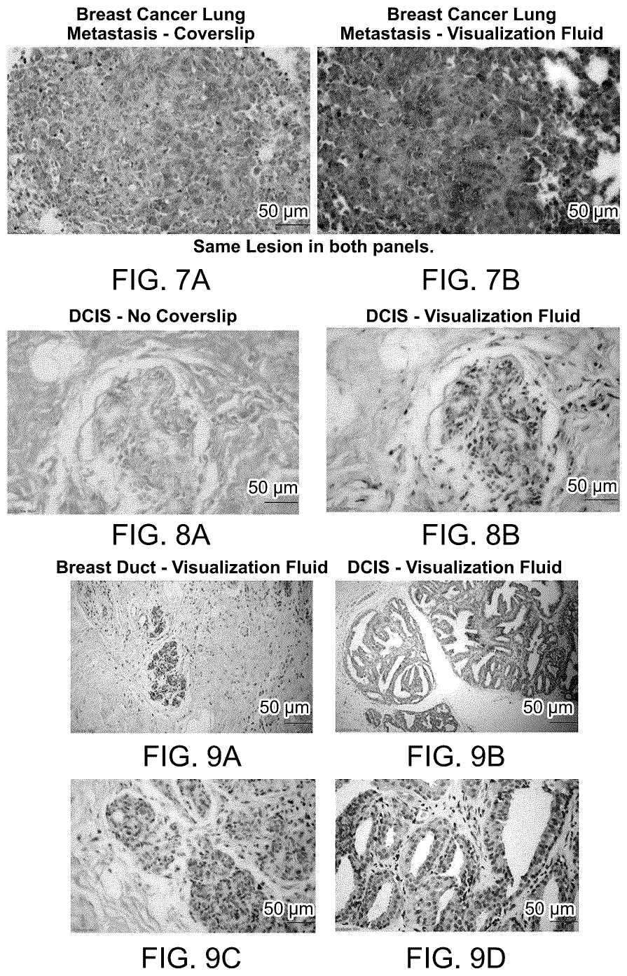

When the non-cover slipped tissue is treated with the visualization fluid, the tissue microscopic image is of high fidelity with a strong dynamic range of color differentiation. The visualization fluid composition achieves nuclear detail compared to standard permount and coverslip (FIGS. 7A-B, 8A-B, 9A-9D, 20A-20C, and 21A-21B).

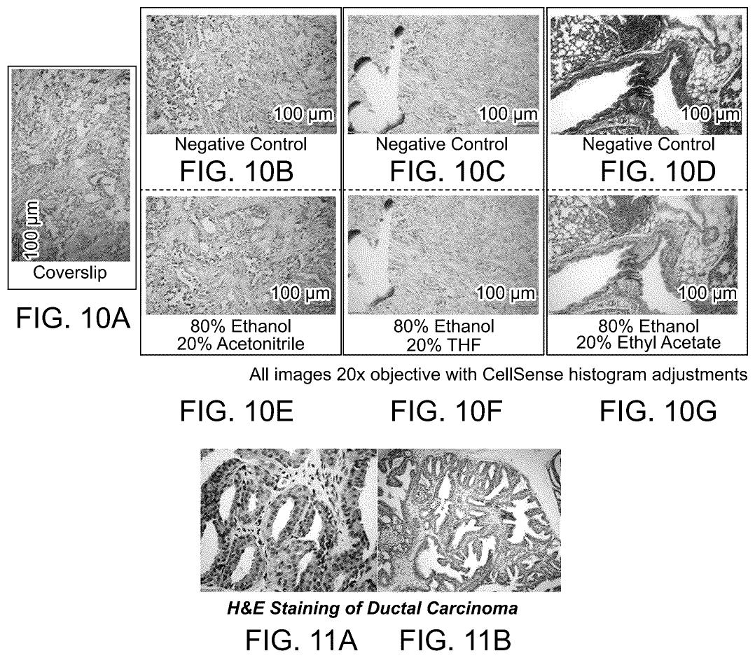

Reduction to practice of various combinations of differing volatile organic liquid chemical components demonstrate successfully improved color differentiation by cell type compared to coverslip alone (FIGS. 10A-10G). Moreover, the addition of a low molecular weight ester, ether, or formate moiety (ethyl acetate) to the volatile organic liquid chemical component (ethanol) provides the greatest color differentiation and sharpest contrast compared to volatile organic compounds alone and/or coverslip alone.

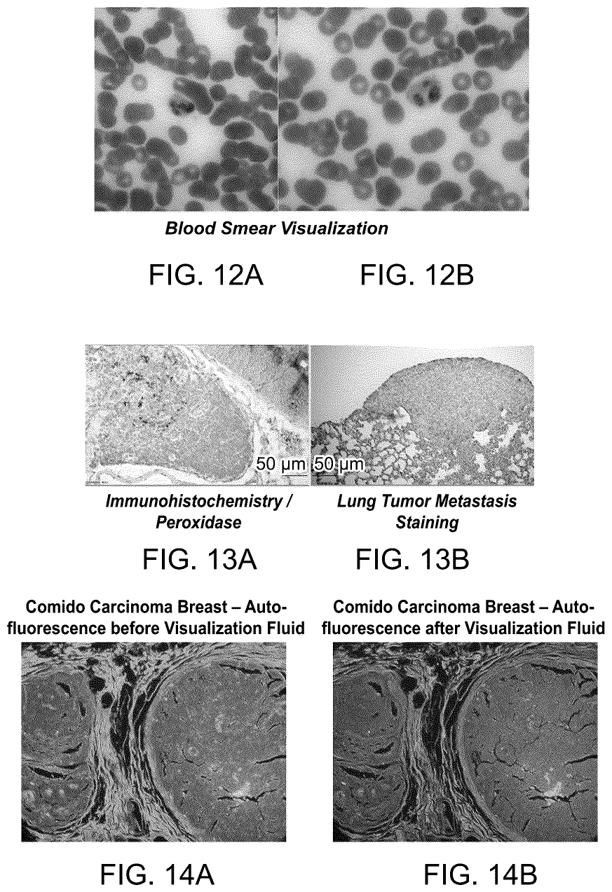

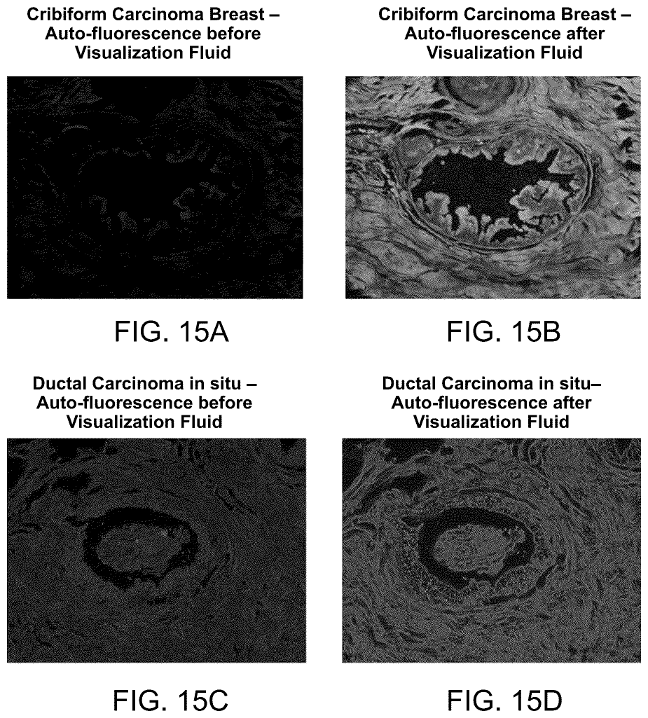

One embodiment of the visualization fluid composition is a fluid containing 30% ethyl acetate (the essential constituent) combined with a volatile base of 70% ethanol. Using the visualization fluid achieves higher tissue image resolution with greater microscopic definition and no alteration or quenching by fluorescent imaging and/or staining (FIGS. 11A-11B, 12A-12B, 13A-13B, 14A-14B, and 15A-15D).

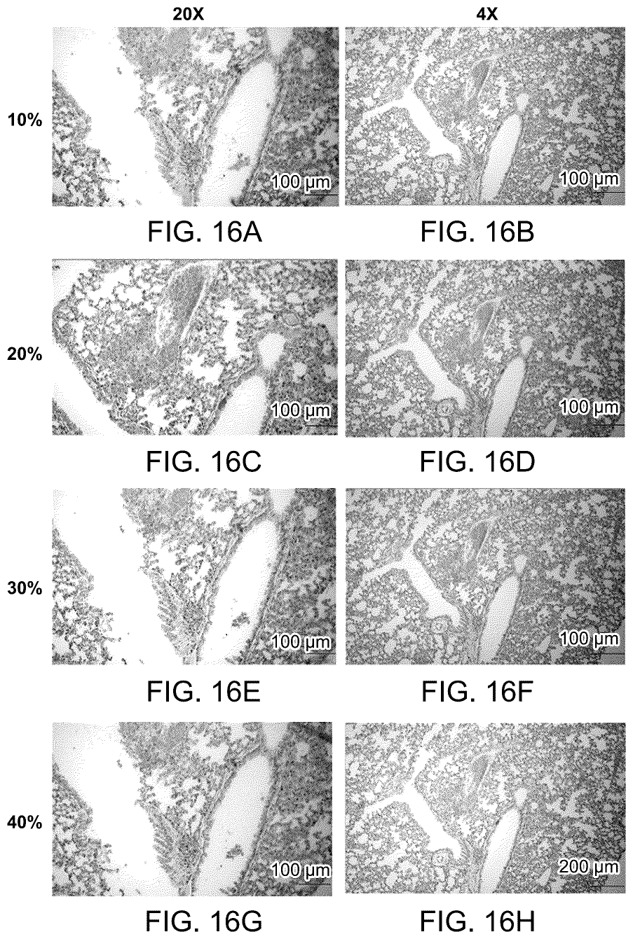

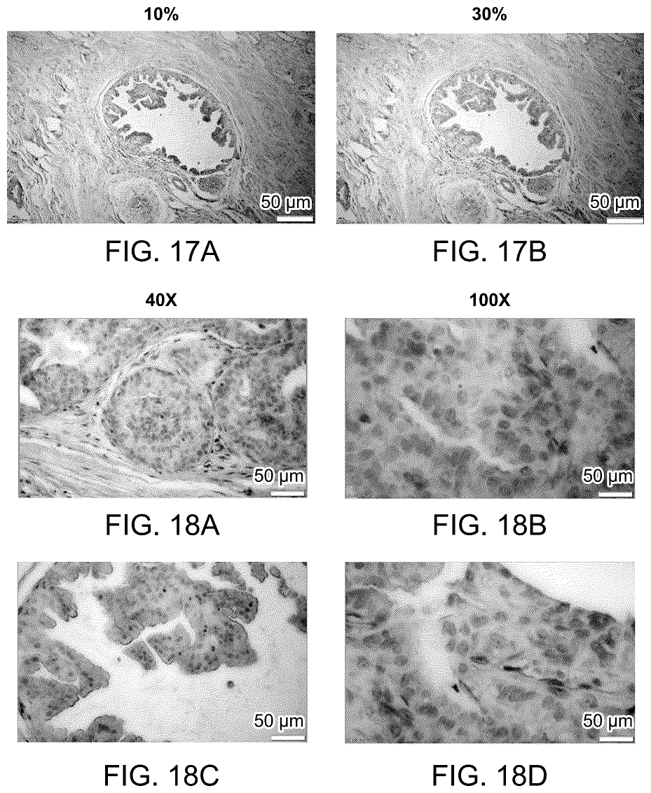

Tissue visualization improves as the low molecular weight ester, ether, or formate moiety concentration increases, as seen by the sharper contrasts between cells and greater color differentiation. There is a specific dose-dependent concentration that permits the visualization fluid. The addition of the low molecular weight ester, ether, or formate moiety in a dose-dependent manner produces sharper contrast and greater color differentiation between different cell types and cellular structures (FIGS. 16A-16H and 17A-17B).

The addition of the low molecular weight ester, ether, or formate moiety in the visualization fluid composition allows for visualization of high magnification cellular structures without the addition of oil immersion or coverslip. (FIG. 18A-18D).

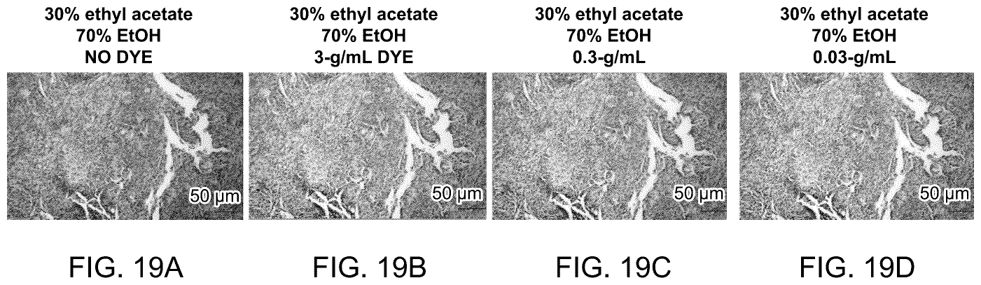

Preservation components consisting of a chemical dye within the 600-650 nm wavelength does not interfere with the visualization fluid composition and tissue visualization (FIGS. 19A-19D).

### Example 2

### Introduction

This study discusses exploring a visualization fluid composed of different volatile compounds with a refractive index near 1.51 and its ability to improve optical qualities of the sample. The experimental approach consists of immunohistochemistry slide staining of different tissues using different classes of chemicals to achieve a refractive index near that of the glass objective lens. It also consists of auto-fluorescent staining images and hematoxylin and eosin (H&E) stained samples.

Laser Capture Microdissection (LCM) is a technique used to obtain a small subpopulation of cells from a tissue sample through the excitation of an EVA polymer film on the surface of a capture cap. The melted EVA polymer will then impregnate the sample with the assistance of gravity, and when the cap is removed, the impregnated sample is still attached to the surface of the cap, so it is effectively obtained. The captured sample can then be used for downstream molecular analyses, such as RPPA.

### Discussion

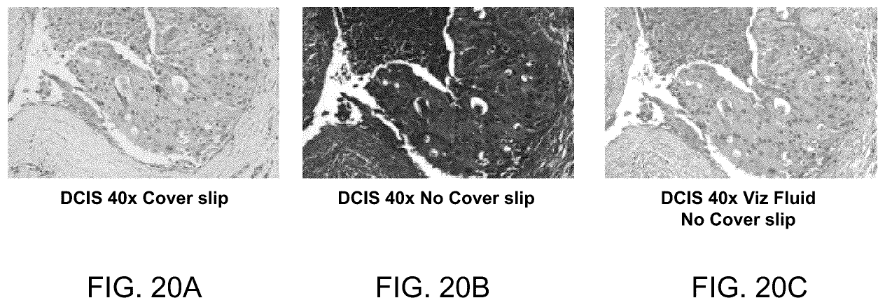

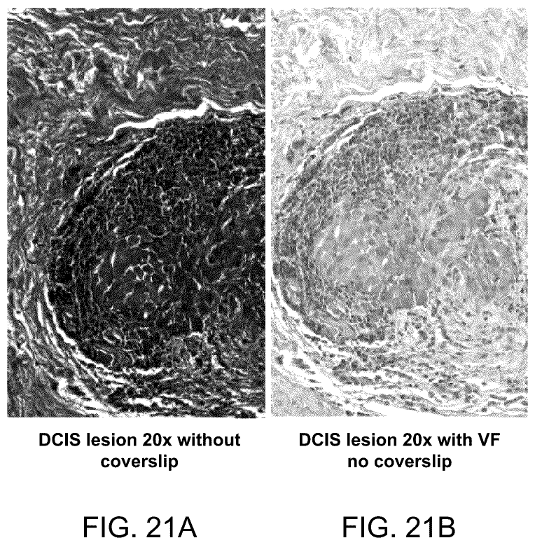

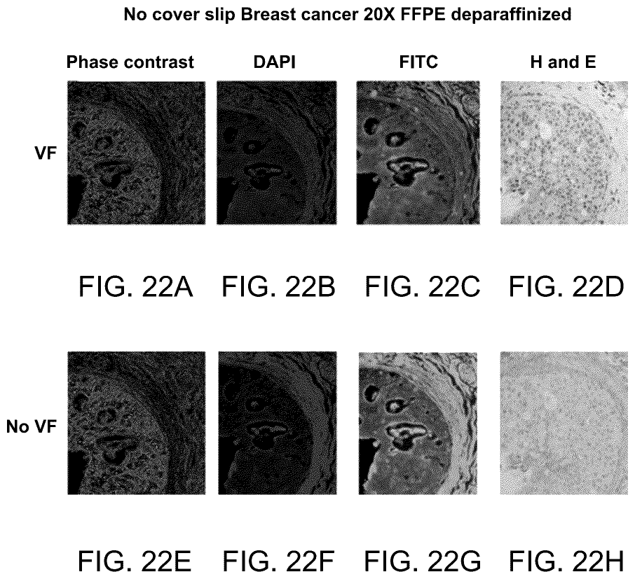

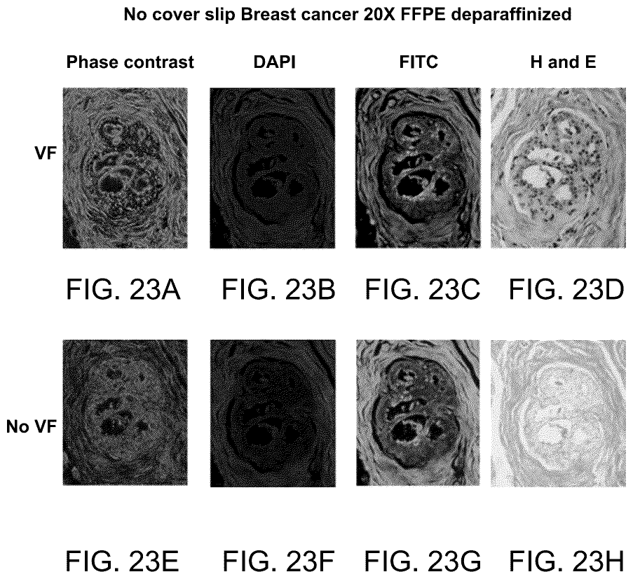

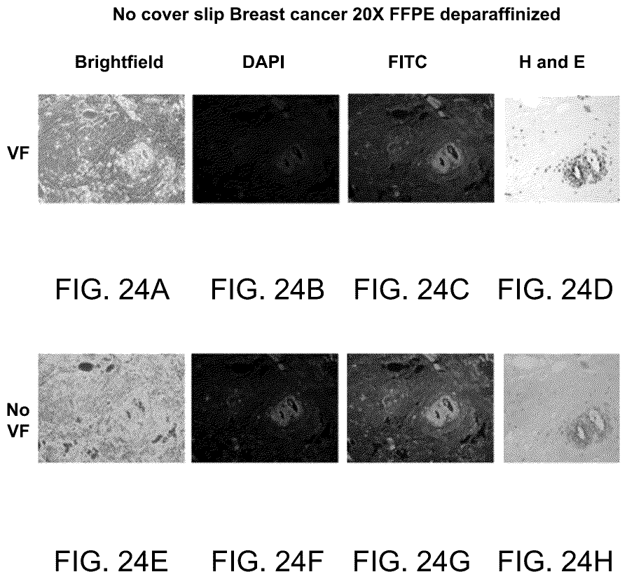

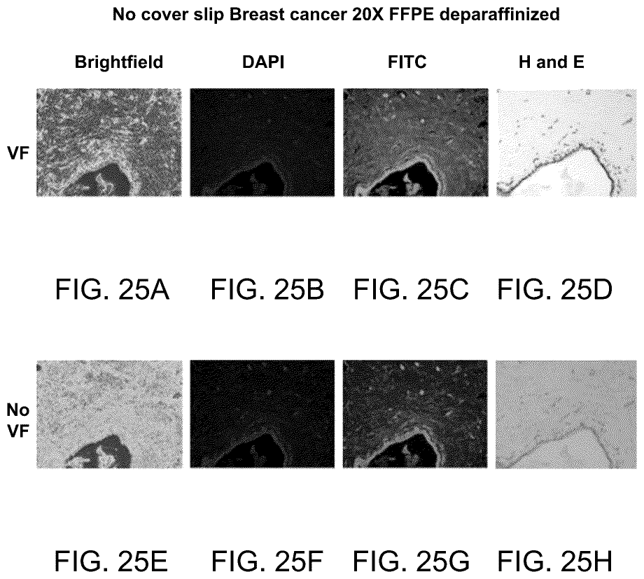

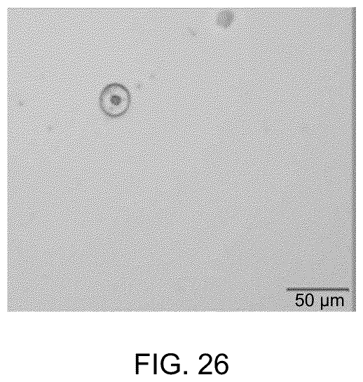

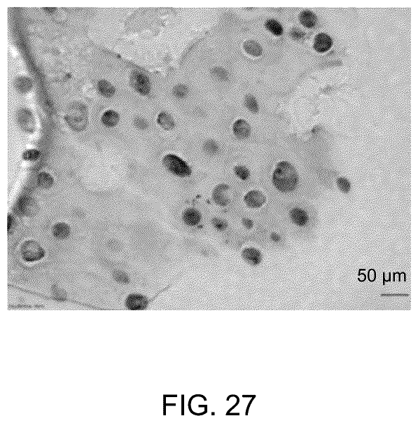

As shown in FIGS. 20A-20G, ethyl acetate functioned best as an additive to ethanol for a visualization fluid (shown in FIG. 20G). The glass objectives have a refractive index of 1.51, while ethanol has a refractive index of 1.36. The addition of the volatile organic liquid chemical component increases the refractive index of the solution, enhancing the visual properties for imaging. Concentration testing of the ethyl acetate was then performed to determine which concentration was highest-performing for visualization and imaging (FIGS. 10A-10H). The 30% ethyl acetate and 70% ethanol solution performed best in this experiment (FIGS. 10E-10F). Use of this solution increased the optical quality of the sample without applying a coverslip and functioned well without impeding other applications, like immunofluorescence imaging, immunohistochemistry imaging, blood smears, and H&E staining (FIGS. 10A-10H, 16A-16H, 22A-22H, 23A-23H, 24A-24D, and 25A-25F). The visualization fluid composition allows for the capture of small portions of a sample once the whole sample has been visualized (FIGS. 26 and 27). In addition, the visualization fluid composition can be used with high magnification lenses instead of immersion oil so as to eliminate the need to clean said lens as the composition is volatile and will evaporate without leaving residue.

In summary, the visualization fluid composition is a versatile tool that enhances the optical properties of the sample without adding a coverslip. This allows for downstream molecular analysis of the sample after imaging, which greatly improves efficiency in the field. The visualization fluid composition allows for high objective imaging without an oil-based immersion fluid that could damage the sample. These high-resolution images may be taken before the sample has a coverslip as well as since the visualization fluid composition will evaporate off the sample. The visualization fluid composition has many applications to different staining and imaging methods, like blood smears, immunohistochemistry staining, H&E staining, and auto-fluorescence imaging.

### Methods

The visualization fluid composition of the present embodiment is approximately 70% ethanol and approximately 30% ethyl acetate. Ethanol and ethyl acetate are both highly volatile organic compounds that can be used to temporarily visualize the sample. Other volatile organic compounds were tested as well, including tetrahydrofuran and acetonitrile.

To visualize the sample of interest, 30 μL of the test solutions were pipetted onto the sample, which would last approximately 1 to approximately 2 minutes. Multiple applications of the solutions were necessary in each imaging session. In some trials, a dye was added to the visualization fluid composition to assist in absorbing the blue 405 nm laser used in LCM. This dye was added into the visualization fluid at a concentration of 3 mg/mL to assist in LCM with a blue laser.

Proper deparaffinization was necessary to administer the visualization fluid and for LCM. To deparaffinize the samples, they were soaked in a series of different organic volatile chemicals. The procedure was: 1) 15 minutes submerged in xylene test tube 1, 2) 15 minutes submerged in xylene test tube 2, 3) 15 minutes submerged in xylene test tube 3, 4) 10 minutes submerged in 100% ethanol test tube 1, 5) 10 minutes submerged in 100% ethanol test tube 2, 6) 10 minutes submerged in 90% ethanol and 10% distilled water test tube 1, 7) 10 minutes submerged in 90% ethanol and 10% distilled water test tube 2, 8) 10 minutes submerged in 70% ethanol and 30% distilled water test tube 1, 9) 10 minutes submerged in 70% ethanol and 30% distilled water test tube 2, and 10) thorough wash with distilled water.

To capture tissue with LCM, it was first stained with hematoxylin and eosin to visualize the regions of interest. The procedure was: 1) 5 seconds submerged in 70% ethanol and 30% distilled water, 2) 10 second submerged in distilled water, 3) 45 seconds submerged in hematoxylin, 4) 10 seconds submerged in distilled water, 5) 15 seconds submerged in Scott's Tap Water (Leica Biosystems, Deer Park, IL), 6) 10 second submerged in 70% ethanol and 30% distilled water, 7) 3 seconds in 70% ethanol and 30% eosin, 8) 10 seconds in 95% ethanol and 5% distilled water, 9) 60 seconds in 95% ethanol and 5% distilled water, 10) 60 seconds in 100% ethanol, 11) 60 seconds in 100% ethanol, 12) 60 seconds in xylene, and 13) 60 seconds in xylene.

When imaging in this experiment, CellSense software was used to apply a white balance adjustment. This allowed the image to filter out the background noise to display the image on a “true white” background. Histogram stretching was also used to enhance the colors within the images to make the nuclei easier to identify. Images were also taken using an auto-fluorescent microscope utilizing DAPI and FITC filters. These images were taken without a coverslip and with use of the visualization fluid composition.

### Equivalents

The present technology is not to be limited in terms of the particular embodiments described in this application, which are intended as single illustrations of individual aspects of the present technology. Many modifications and variations of this present technology can be made without departing from its spirit and scope, as will be apparent to those skilled in the art. Functionally equivalent methods and apparatuses within the scope of the present technology, in addition to those enumerated herein, will be apparent to those skilled in the art from the foregoing descriptions. Such modifications and variations are intended to fall within the scope of the present technology. It is to be understood that this present technology is not limited to particular methods, compounds, compositions or biological systems, which can, of course, vary. It is also to be understood that the terminology used herein is for the purpose of describing particular embodiments only and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2 or 3 cells.

All patents, patent applications, provisional applications and publications referred to or cited herein are incorporated by reference in their entirety, including all figures and tables, to the extent they are not inconsistent with the explicit teachings of this specification.

1. A visualization fluid composition comprising:
a) a low molecular weight ester, ether, or formate moiety;
b) a volatile organic liquid chemical component;
c) stabilization components;
d) preservation components; and
e) an image color adjusting moiety.

2. The composition of claim 1, wherein the low molecular weight ester, ether, or formate moiety comprises one or more of: a) a refractive index between 1.3 and 1.5, b) an optical clarity defined as greater than 90% transmittance of incident light of the range of 400 to 800 nm, c) a vapor pressure between 5 and 25 kPa at room temperature, and d) less than 1% water content.

3. The composition of claim 1, wherein the low molecular weight ester, ether, or formate moiety comprises: a) a short-chain acetate compound, b) a short-chain formate compound, or c) a mixture of at least one short-chain acetate compound and at least one short-chain formate compound

4. The composition of claim 3, wherein the short-chain acetate compound comprises a) ethyl acetate, b) methyl acetate, c) propyl acetate, d) butyl acetate, or e) any isomer or combination of isomers thereof.

5. The composition of claim 3, wherein the short-chain organic formate compound comprises: a) methyl formate, b) ethyl formate, c) propyl formate, d) butyl formate, or e) any isomer or combination of isomers thereof.

6. The composition of claim 1, wherein the volatile organic liquid chemical component comprises one or more of: a) a refractive index between 1.3 and 1.5, b) an optical clarity defined as greater than 90% transmittance of incident light of the range of 400 to 800 nm, c) a vapor pressure between 5 and 25 kPa at room temperature, and d) less than 1% water content.

7. The composition of claim 1, wherein the volatile organic liquid chemical component comprises: a) a short-chain alcohol solvent, b) a mixture of short-chain alcohol solvents, c) acetonitrile, d) a mixture of short-chain alcohol solvents and acetonitrile, or e) a mixture of short-chain acetate compounds and short-chain formate compounds.

8. The composition of claim 7, wherein the short-chain alcohol solvent comprises a) methanol, b) ethanol, c) propanol, or d) any isomer or combination of isomers thereof

9. The composition of claim 1, wherein the stabilization components comprise hygroscopic salts.

10. The composition of claim 9, wherein the hygroscopic salts comprise a) calcium chloride, b) calcium sulfate, c) magnesium sulfate, d) potassium sulfate, or e) sodium sulfate.

11. The composition of claim 1, wherein the preservation component comprises a denaturant chemical component to prevent degradation of analytes within the tissue sample.

12. The composition of claim 1, wherein the preservation component comprises one or more of the following: a) a chaotropic agent, b) an RNase inhibitor, or c) a combination thereof

13. The composition of claim 12, wherein the RNase inhibitor is Ribonucleoside Vanadyl Complex.

14. The composition of claim 1, wherein the image color adjusting moiety comprises a chemical dye within the 600 to 650 nm wavelength.

15. A container comprising:
a) a bulb or dropper region containing the composition of claim 1;
b) a tear-off or twist-off seal, wherein removing the tear-off or twist-off seal exposes the bulb or dropper region; and
c) a dispensing spout,
wherein the container is made of a material that is inert to degradation by the composition or components thereof.

16. The container of claim 15, wherein the container comprises a filter paper or a filter between the bulb or dropper region and the dispensing spout.

17. A method of visualizing tissues, the method comprising:
a) applying a visualization fluid composition onto a sample mounted onto a slide by an operator,
b) scanning and imaging the slide digitally and/or optically and/or microscopically,
c) analyzing the images of the slides to identify a region of interest, and
d) conducting molecular analysis of the designated regions of interest.

18. The method of claim 17, wherein the visualization fluid composition comprises: a) a low molecular weight ester, ether, or formate moiety; b) a volatile organic liquid chemical component, c) stabilization components, d) preservation components, and e) an image color adjusting moiety.

19. The method of claim 18, wherein the low molecular weight ester, ether, or formate moiety has one or more of: a) a refractive index between 1.3 and 1.5, b) an optical clarity defined as greater than 90% transmittance of incident light of the range of 400 to 800 nm, c) a vapor pressure between 5 and 25 kPa at room temperature, and d) less than 1% water content.

20. The method of claim 18, wherein the low molecular weight ester, ether, or formate moiety comprises at least one of: a) a short-chain acetate compound, b) a short-chain formate compound, or c) a mixture of at least one short-chain acetate compound and at least one short-chain formate compound.

21. The method of claim 20, wherein the short-chain acetate compound comprises at least one of a) ethyl acetate, b) methyl acetate, c) propyl acetate, d) butyl acetate, or e) any isomer or combination of isomers thereof.

22. The method of claim 20, wherein the short-chain organic formate compound comprises at least one of a) methyl formate, b) ethyl formate, c) propyl formate, d) butyl formate, or e) any isomer or combination of isomers thereof.

23. The method of claim 18, wherein the volatile organic liquid chemical component has one or more of the following properties: a refractive index between 1.3 and 1.5, an optical clarity defined as greater than 90% transmittance of incident light in the range of 400 to 800 nm, a vapor pressure between 5 and 25 kPa at room temperature, and less than 1% water content.

24. The method of claim 18, wherein the volatile organic liquid chemical component comprises: a) a short-chain alcohol solvent, b) a mixture of short-chain alcohol solvents, c) acetonitrile, d) a mixture of short-chain alcohol solvents and acetonitrile, or e) a mixture of short-chain acetate compounds and short-chain formate compounds.

25. The method of claim 24, wherein the short-chain alcohol solvent comprises a) methanol, b) ethanol, c) propanol, or d) any isomer or combination of isomers thereof

26. The method of claim 18, wherein the stabilization components comprise hygroscopic salts.

27. The method of claim 26, wherein the hygroscopic salts comprise a) calcium chloride, b) calcium sulfate, c) magnesium sulfate, d) potassium sulfate, or e) sodium sulfate.

28. The method of claim 18, wherein the preservation component comprises a denaturant chemical component that prevents degradation of analytes within the tissue sample.

29. The method of claim 18, wherein the preservation component comprises one or more of the following: a) a chaotropic agent, b) an RNase inhibitor, or c) a combination thereof.

30. The method of claim 29, wherein the RNase inhibitor is Ribonucleoside Vanadyl Complex.

31. The method of claim 18, wherein the image color adjusting moiety comprises a chemical dye within the 600 to 650 nm wavelength.

32. The method of claim 17, wherein the operator is a human user or an automated device.

33. The method of claim 17, wherein the analysis of the images in step (c) is conducted without further direct visual inspection of the sample.

34. The method of claim 17, wherein the analysis of the images in step (c) comprises applying, to the images, a normalization process to modify the images.

35. The method of claim 17, wherein the analysis of the images in step (c) comprises subjecting the images to machine-learning processing to identify the regions of interest.

36. The method of claim 17, wherein the method further comprises sending the analyzed image electronically to a receiver.

37. The method of claim 36, wherein the receiver is a user or an automated device.

38. The method of claim 17, wherein the method further comprises e) microdissecting or microsampling the regions of interest based on the results of the molecular analysis, without additional optical or microscopic visualization of the sample.

39. The method of claim 17, wherein the method further comprises e) placing a thin UV-permeable thermo-polymer microdissection film or coverslip with embedded near-UV absorbing dye on the top of the surface, f) using a near-UV flash computer system to mask regions of the sample that are not regions of interest, and g) microdissecting regions of the sample that are not masked onto the microdissection film or coverslip.

40. The method of claim 39, comprising further analyzing the regions of the sample that have been microdissected onto the microdissection film or coverslip.
